(19) United States
(12) Patent Application Publication
(10) Pub. No.: US 2013/0075024 A1
(43) Pub. Date: Mar. 28, 2013

(54) CURABLE COMPOSITION FOR IMAGE RECORDING, METHOD FOR PRODUCING THE SAME, IMAGE RECORDING APPARATUS, AND METHOD FOR RECORDING IMAGE

(71) Applicant: Yoshiro YAMASHITA, Kanagawa (JP)

(72) Inventor: Yoshiro YAMASHITA, Kanagawa (JP)

(73) Assignee: FUJI XEROX CO., LTD., Tokyo (JP)

(21) Appl. No.: 13/447,974

(22) Filed: Apr. 16, 2012

(30) Foreign Application Priority Data
Sep. 26, 2011 (JP) 2011-209855

(51) Int. Cl. C09D 143/04; B44C 1/17

(52) U.S. Cl. 156/240; 156/390; 524/506

(57) ABSTRACT

A curable composition for image recording contains a curable material that is curable by a stimulus from the outside, and liquid-absorbing particles that have a volume-average particle diameter in a range from about 50 nm to about 1,500 nm and a ratio volume-average particle diameter/number-average particle diameter in a range from about 1.0 to about 1.2 and that are dispersed in the curable material without aggregation.

### CROSS-REFERENCE TO RELATED APPLICATIONS

This application is based on and claims priority under 35 USC 119 from Japanese Patent Application No. 2011-209855 filed Sep. 26, 2011.

### BACKGROUND

(i) Technical Field

The present invention relates to a curable composition for image recording, a method for producing the same, an image recording apparatus, and a method for recording an image.

(ii) Related Art

An example of a method for recording an image or data using an ink is an ink-jet recording method. In the ink-jet recording method, a liquid ink or a molten solid ink is ejected from a nozzle, a slit, a porous film, or the like to conduct recording on paper, a cloth, a film, or the like.

In such a recording method using an ink, in order to conduct recording on various recording media such as a permeable medium and a non-permeable medium with high image quality, a method has been proposed in which a layer composed of a composition for image recording is formed on an intermediate transfer body, an ink is applied onto the composition layer to record an image in advance, and the composition layer on which the image has been recorded is then transferred to a recording medium such as paper and cured.

### SUMMARY

According to an aspect of the invention, there is provided a curable composition for image recording, the curable composition containing a curable material that is curable by a stimulus from the outside, and liquid-absorbing particles that have a volume-average particle diameter in a range from about 50 nm to about 1,500 nm and a ratio volume-average particle diameter/number-average particle diameter in a range from about 1.0 to about 1.2 and that are dispersed in the curable material without aggregation.

### BRIEF DESCRIPTION OF THE DRAWINGS

Exemplary embodiments of the present invention will be described in detail based on the following figures, wherein:

FIG. 1 is a schematic view illustrating a curable composition layer formed on an intermediate transfer body using a curable composition according to an exemplary embodiment;

FIG. 2 is a schematic view illustrating a state where an ink is applied onto the curable composition layer illustrated in FIG. 1 and the curable composition layer is then transferred to a recording medium;

FIG. 3 is a view illustrating a ratio of a maximum distance of a difference between a top and a bottom of irregularities on the surface of a liquid-absorbing particle to a particle diameter of the liquid-absorbing particle;

FIG. 4 is a view illustrating the structure of an image recording apparatus according to an exemplary embodiment;

FIG. 5 is a schematic view illustrating aggregate liquid-absorbing particles; and

FIG. 6 is a schematic view illustrating a state where an ink is applied onto a curable composition layer in which liquid-absorbing particles are aggregated and the curable composition layer is then transferred to a recording medium.

### DETAILED DESCRIPTION

An exemplary embodiment of the invention will now be described with reference to the drawings.

In the case where an image is formed by forming a curable composition layer containing liquid-absorbing particles and a curable material on an intermediate transfer body, applying a water-based ink onto the curable composition layer by an ink jet method, and then transferring the curable composition layer to a recording medium while providing energy, a decrease in glossiness may occur during storage, though the curable composition has been cured by the provided energy to form a cured film. This decrease in glossiness occurs particularly in a portion where the image is not formed (non-image portion). Although the mechanism of this decrease in glossiness is not completely clear, it is assumed to be as follows.

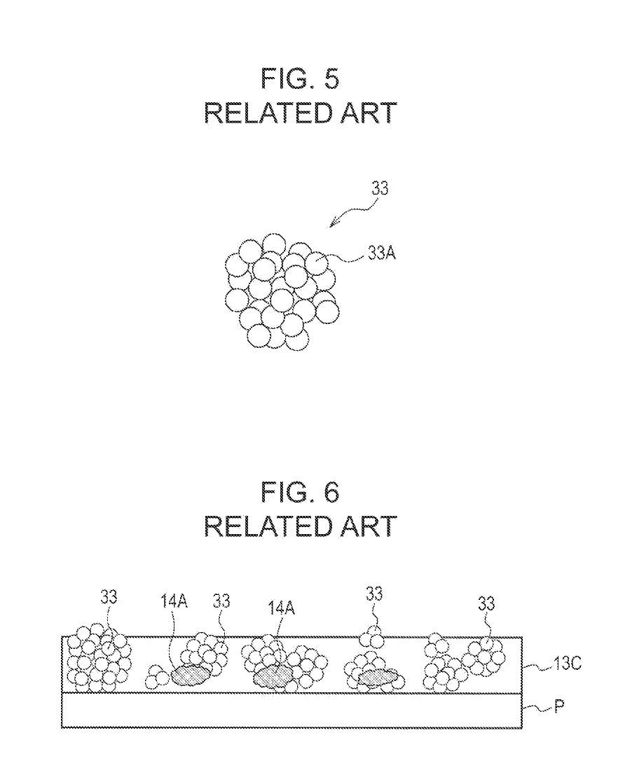

In an existing curable composition, for example, as illustrated in FIG. 5, particles (aggregate particles) 33 formed by secondary aggregation of primary particles 33A of liquid-absorbing particles, or particles that have been subjected to a pulverization process are used. Such aggregate particles and particles that have been subjected to a pulverization process usually have a particle diameter of about 5 μm, a wide particle size distribution ranging from a particle diameter of less than 1 μm to about 30 μm, and large irregularities on the surfaces of the particles, though the sizes of irregularities differ from one another. In particular, aggregate liquid-absorbing particles and liquid-absorbing particles having large irregularities on the surfaces thereof do not completely absorb a liquid to the inner side of the particles. Thus, it is necessary to increase the content of the particles in order to achieve a satisfactory image quality by absorbing an ink.

After the ink is applied onto the curable composition layer on the intermediate transfer body, the curable composition layer is transferred to a recording medium in a state where the upper surface and the lower surface of the curable composition layer are inverted. Therefore, some of liquid-absorbing particles remain in a state of not being completely covered with the resulting film cured by energy. Furthermore, because of the influence of the shape and the size of the liquid-absorbing particles in the cured layer, as illustrated in FIG. 6, parts of some of the aggregate particles 33 are exposed to the surface of a cured film 13C. Thus, it is believed that the exposed aggregate particles 33 absorb a liquid or moisture, thereby decreasing glossiness. In addition, in the case where a recording medium P is composed of an air-permeable material, the liquid-absorbing particles 33 absorb moisture also from the side of a surface that is adhered to the recording medium P. This is also believed to be a cause of a decrease in glossiness.

As a result of intensive studies, the inventor of the present invention found that a decrease in glossiness due to moisture absorption may be suppressed and an image with a higher definition may be obtained by using liquid-absorbing particles having a relatively small particle diameter and a narrow particle size distribution and preparing a curable composition in which such liquid-absorbing particles are dispersed in a curable material without aggregation.

### Curable Composition for Image Recording

A curable composition for image recording (hereinafter may be referred to as “curable composition”) according to an exemplary embodiment is liquid and contains a curable material that is curable by a stimulus from the outside and liquid-absorbing particles that have a volume-average particle diameter in a range from 50 nm to 1,500 nm or in a range from about 50 nm to about 1,500 nm and a ratio volume-average particle diameter/number-average particle diameter in a range from 1.0 to 1.2 or in a range from about 1.0 to about 1.2 and that are dispersed in the curable material without aggregation.

In the curable composition for image recording according to this exemplary embodiment, liquid-absorbing particles having a small particle diameter and a narrow particle size distribution are dispersed in a curable material without aggregation. Accordingly, it is believed that when the curable composition is formed as a curable composition layer on an intermediate transfer body and further on a recording medium, the formation of coarse aggregate particles of the liquid-absorbing particles and the exposure of such aggregate particles to a surface of the curable composition layer (cured film) may be suppressed, thus suppressing a decrease in glossiness due to moisture absorption of the liquid-absorbing particles exposed at the surface of the curable composition layer even after image recording.

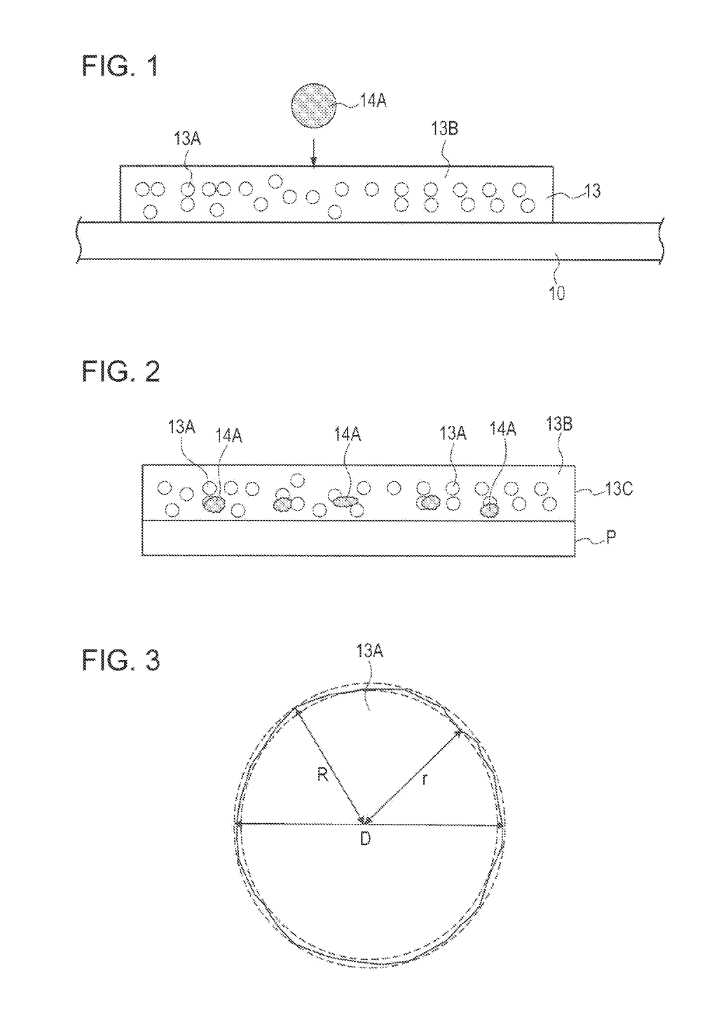

For example, as illustrated in FIG. 1, in a curable composition layer 13 formed on an intermediate transfer body 10 using the curable composition according to this exemplary embodiment, liquid-absorbing particles 13A are dispersed in a curable material 13B in the form of primary particles without aggregation. An ink 14A is applied onto the curable composition layer 13, and the curable composition layer 13 is then transferred to a recording medium P in a state where the upper surface and the lower surface of the curable composition layer 13 are inverted. As illustrated in FIG. 2, the ink 14A applied to the curable composition layer 13 is retained by being absorbed in the liquid-absorbing particles 13A. It is believed that moisture absorption after image recording is suppressed because most of the liquid-absorbing particles 13A are dispersed in the form of primary particles and the exposure of the liquid-absorbing particles 13A from the upper and lower surfaces of the cured film 13C cured by supplying a stimulus to the curable composition layer 13 is suppressed. Furthermore, it is assumed that since the liquid-absorbing particles 13A are dispersed in the form of primary particles, respective portions of the ink 14A are also finely retained by the liquid-absorbing particles 13A, and thus a high-definition image is formed.

—Curable material—

The “curable material that is curable by a stimulus from the outside” contained in the curable composition according to this exemplary embodiment means a material that is cured by a stimulus (energy) from the outside and turned into a “curable resin”. Specific examples thereof include curable monomers, curable macromers, curable oligomers, and curable prepolymers.

Examples of the curable material include ultraviolet-curable materials, electron-beam-curable materials, and thermosetting materials. Ultraviolet-curable materials are the most desirable because they are easily cured, the curing rate thereof is higher than that of other curable materials, and they are easily handled. Regarding electron-beam-curable materials, a polymerization initiator is unnecessary and coloration of the resulting layer after curing may be easily controlled. Thermosetting materials may be cured without using a large-scale device. The curable material is not limited thereto. Alternatively, for example, curable materials that are curable by moisture, oxygen, or the like may also be used. Note that the curable material used herein is irreversible after curing.

Examples of the “ultraviolet-curable resin” obtained by curing an ultraviolet-curable material include acrylic resins, methacrylic resins, urethane resins, polyester resins, maleimide resins, epoxy resins, oxetane resins, polyether resins, and polyvinyl ether resins. A curable composition thereof contains at least one of an ultraviolet-curable monomer, an ultraviolet-curable macromer, an ultraviolet-curable oligomer, and an ultraviolet-curable prepolymer. The curable composition may contain an ultraviolet polymerization initiator for allowing an ultraviolet curing reaction to proceed. The curable composition may further contain a reaction auxiliary agent, a polymerization accelerator, and the like for further allowing a polymerization reaction to proceed, as required.

Examples of the ultraviolet-curable monomer include radically curable materials such as acrylic acid esters of an alcohol, a polyhydric alcohol, or an amino alcohol, methacrylic acid esters of an alcohol or a polyhydric alcohol, acrylic aliphatic amides, acrylic alicyclic amides, acrylic aromatic amides; and cationically curable materials such as epoxy monomers, oxetane monomers, and vinyl ether monomers. Examples of the ultraviolet-curable macromer, the ultraviolet-curable oligomer, and the ultraviolet-curable prepolymer include not only products obtained by polymerizing any of these monomers but also radically curable materials such as epoxy acrylates, urethane acrylates, polyester acrylates, polyether acrylates, urethane methacrylates, and polyester methacrylates in which an acryloyl group or a methacryloyl group is added to an epoxy, urethane, polyester, or polyether backbone.

In the case where the curing reaction proceeds through a radical reaction, examples of the ultraviolet polymerization initiator include benzophenone, thioxanthone-based initiators, benzyl dimethyl ketal, α-hydroxy ketones, α-hydroxyalkyl phenones, α-amino ketones, α-amino alkyl phenones, monoacylphosphine oxides, bisacylphosphine oxides, hydroxybenzophenone, aminobenzophenone, titanocene-type initiators, oxime ester-type initiators, and oxyphenyl acetate-type initiators.

In the case where the curing reaction proceeds through a cationic reaction, examples of the ultraviolet polymerization initiator include aryl sulfonium salts, aryl diazonium salts, diaryl iodonium salts, triaryl sulfonium salts, allene-ion complex derivatives, and triazine-based initiators.

Examples of the “electron-beam-curable resin” obtained by curing an electron-beam-curable material include acrylic resins, methacrylic resins, urethane resins, polyester resins, polyether resins, and silicone resins. A curable composition thereof contains at least one of an electron-beam-curable monomer, an electron-beam-curable macromer, an electron-beam-curable oligomer, and an electron-beam-curable prepolymer.

Examples of the electron-beam-curable monomer, the electron-beam-curable macromer, the electron-beam-curable oligomer, and the electron-beam-curable prepolymer include the same as the ultraviolet-curable materials.

Examples of the “thermosetting resin” obtained by curing a thermosetting material include epoxy resins, polyester resins, phenolic resins, melamine resins, urea resins, and alkyd resins. A curable composition thereof contains at least one of a thermosetting monomer, a thermosetting macromer, a thermosetting oligomer, and a thermosetting prepolymer. A curing agent may be added to the curable composition in conducting the polymerization. The curable composition may contain a thermal polymerization initiator for allowing a thermosetting reaction to proceed.

Examples of the thermosetting monomer include phenol, formaldehyde, bisphenol A, epichlorohydrin, cyanuramide, urea, polyhydric alcohols such as glycerin, and acids such as phthalic anhydride, maleic anhydride, and adipic acid. Examples of the thermosetting macromer, the thermosetting oligomer, and the thermosetting prepolymer include products obtained by polymerizing any of these monomers, epoxy prepolymers, and polyester prepolymers.

Examples of the thermal polymerization initiator include acids such as protonic acids and Lewis acids, alkali catalysts, and metal catalysts.

As described above, any curable material may be used as long as the material is cured by external energy such as ultraviolet rays, an electron beam, or heat (for example, cured by progress of a polymerization reaction).

Among the above curable materials, materials having a high curing rate (for example, materials having a high rate of polymerization reaction) are preferable from the standpoint of realization of high-speed image recording. Examples of such curable materials include radiation-curable materials (such as ultraviolet-curable materials and electron-beam curable materials).

The curable material may be modified with silicon, fluorine, or the like in consideration of wettability with the intermediate transfer body etc. Considering the curing rate and the degree of curing, the curable material preferably contains a multifunctional prepolymer.

The curable composition may contain water or an organic solvent for dissolving or dispersing main components (monomers, macromers, oligomers, prepolymers, polymerization initiators, and the like) that contribute to a curing reaction. However, the ratio of the main components is, for example, 30% by mass or more, preferably 60% by mass or more, and more preferably 90% by mass or more.

The curable composition may contain a coloring material for the purpose of controlling the coloring of the layer after curing.

The curable composition has a viscosity preferably in a range from 5 mPa·s to 10,000 mPa·s, more preferably 10 mPa·s to 1,000 mPa·s, and more preferably 15 mPa·s to 500 mPa·s. The viscosity of the curable composition is preferably higher than the viscosity of the ink.

—Liquid-absorbing particles—

The liquid-absorbing particles contained in the curable composition according to this exemplary embodiment have a volume-average particle diameter in a range from 50 nm to 1,500 nm or in a range from about 50 nm to about 1,500 nm and a ratio volume-average particle diameter/number-average particle diameter in a range from 1.0 to 1.2 or in a range from about 1.0 to about 1.2, and are dispersed in the curable material without aggregation. Note that all the liquid-absorbing particles contained in the curable composition according to this exemplary embodiment need not be present in the form of primary particles. With an increase in the content ratio of the liquid-absorbing particles, the liquid-absorbing particles tend to aggregate. However, even if only some of the liquid-absorbing particles have aggregated, a decrease in glossiness after image recording is suppressed. Among the total number N of the liquid-absorbing particles (the sum of the number N₁ of primary particles and the number N₂ of secondary particles) contained in the curable composition, preferably 50% by number or more, more preferably 70% by number or more, and still more preferably 80% by number or more are dispersed in the form of primary particles.

The percentage by number of primary particles among the liquid-absorbing particles contained in the curable composition is determined by observing 1,000 liquid-absorbing particles randomly chosen from the curable composition with a microscope.

### (Volume-Average Particle Diameter) and (Ratio of Volume-Average Particle Diameter/Number-Average Particle Diameter)

A volume-average particle diameter (Mv) and a ratio volume-average particle diameter/number-average particle diameter (Mv/Mn) of the liquid-absorbing particles are measured by a method described below using a dynamic light-scattering particle size/particle size distribution analyzer Nanotrac UPA (manufactured by Nikkiso Co., Ltd.). Numerical values described herein are values measured by the method.

In the measuring method, a diluted aqueous dispersion having a particle concentration of about 0.01% by mass is measured using Nanotrac UPA at about 23° C.

Liquid-absorbing particles having a volume-average particle diameter in a range from 50 nm to 1,500 nm or in a range from about 50 nm to about 1,500 nm have a small particle diameter, and thus have a large specific surface area. In addition, since a distance from the surface of a particle to the center thereof is relatively small, absorption of a liquid to the inside of the particle also easily proceeds. Therefore, even when the content of the particles is relatively small, an ink is sufficiently absorbed. The volume-average particle diameter of the liquid-absorbing particles is preferably in a range from 200 nm to 1,200 nm, and more preferably in a range from 300 nm to 1,100 nm.

When the ratio of the volume-average particle diameter to the number-average particle diameter (Mv/Mn) of the liquid-absorbing particles is in a range from 1.0 to 1.2 or in a range from about 1.0 to about 1.2, the particle size distribution is narrow, coarse particles are hardly contained, and it is sufficient to use a small amount of liquid-absorbing particles. Accordingly, exposure of the liquid-absorbing particles to the surface of a cured film is suppressed, and the liquid-absorbing particles are substantially covered with the curable material. (Ratio of maximum distance of surface irregularities to particle diameter of liquid-absorbing particle)

A ratio of a maximum distance of a difference between a top and a bottom of irregularities on the surface of a liquid-absorbing particle (hereinafter may be referred to as “maximum distance of surface irregularities”) to a particle diameter of the liquid-absorbing particle is preferably less than 5% or less than about 5%. The smaller this ratio, the smaller the irregularities on the surface of the liquid-absorbing particle and the closer to a spherical shape the particle shape becomes. The ratio is measured with a transmission electron microscope (TEM) or a scanning electron microscope (SEM). When a liquid-absorbing particle is observed with an electron microscope, for example, as illustrated in FIG. 3, the diameter of a circle circumscribed about the outline of a liquid-absorbing particle 13A is represented by D, the radius of the circumscribed circle is represented by R, and the radius of a circle that is concentric with the circumscribed circle and is inscribed in the outline of the liquid-absorbing particle 13A is represented by r. In this case, D is defined as a particle diameter of the liquid-absorbing particle 13A and (R−r) is defined as a maximum distance of a difference between a top and a bottom of irregularities on the surface of the liquid-absorbing particle 13A. A ratio (%) of the maximum distance of surface irregularities to the particle diameter of the liquid-absorbing particle 13A is calculated as [(R−r)/D]×100. The average calculated for 20 liquid-absorbing particles in the curable composition by this method is defined as the ratio of a maximum distance of surface irregularities to the particle diameter of the liquid-absorbing particle 13A. When this ratio is less than 5% or less than about 5%, the shape of each of the liquid-absorbing particles 13A is close to a spherical shape. Thus, the surfaces of the liquid-absorbing particles 13A are easily coated with the curable material, and moisture absorption after curing (during storage) is effectively suppressed.

Since each of the liquid-absorbing particles has a smooth surface shape, even in a state where the curable composition layer is transferred to a recording medium, the surface of the curable composition layer is substantially covered with the curable material, and the liquid-absorbing particles are sufficiently covered with the curable material also in a film cured by energy. Furthermore, in the case where the recording medium is composed of an air-permeable material, a surface adhered to the recording medium is also covered with a cured film, and thus moisture absorption from the recording medium side is also suppressed.

Accordingly, liquid absorption and moisture absorption after curing are suppressed, and a decrease in glossiness does not tend to occur. In addition, since the shape and the size of the particles are uniform, the level of the image quality is improved, and adhesion to the recording medium is also improved.

Examples of the material of the liquid-absorbing particles include hydrophilic polymers (water-absorbing resins) having a liquid-absorbing site such as a carboxylic acid (or a carboxylate).

The water-absorbing resin is an organic resin having a hydrophilic group for the purpose of absorbing water, which is a liquid component (solvent) in a water-based ink.

The water-absorbing resin may be, for example, a homopolymer of a hydrophilic monomer having a hydrophilic group or a copolymer of a hydrophilic monomer having a hydrophilic group and a hydrophobic monomer having a hydrophobic group. The water-absorbing resin may be a graft copolymer or block copolymer obtained by copolymerizing not only a monomer unit but also a unit having, for example, a polymer/oligomer structure, the unit serving as a starting material, with other units.

Examples of the hydrophilic group include —OH, an -EO unit (ethylene oxide group), —COOM (where M is, for example, a hydrogen atom, an alkali metal such as Na, Li, or K, ammonia, or an organic amine), —SO₃M (where M is, for example, a hydrogen atom, an alkali metal such as Na, Li, or K, ammonia, or an organic amine), —NR₃ (where each R is, for example, a hydrogen atom, an alkyl, or a phenyl), and —NR₄X (where each R is, for example, a hydrogen atom, an alkyl, or a phenyl and X is, for example, a halogen, sulfate radical, an anion of an acid such as a carboxylic acid, or BF₄).

Specific examples of the hydrophilic monomer include 2-hydroxyethyl methacrylate, 2-hydroxyethyl acrylate, acrylamide, acrylic acid, methacrylic acid, unsaturated carboxylic acids, crotonic acid, and maleic acid. Examples of a polar monomer include cellulose derivatives such as cellulose, ethyl cellulose, and carboxymethyl cellulose; starch derivatives; monosaccharide/polysaccharide derivatives; vinyl sulfonic acid; styrene sulfonic acid; polymerizable carboxylic acids such as acrylic acid, methacrylic acid, and maleic acid (anhydride); (partially) neutralized salts thereof; vinyl alcohols; derivatives such as vinylpyrrolidone, vinylpyridine, amino (meth)acrylate, and dimethylamino (meth)acrylate; onium salts thereof; amides such as acrylamide and isopropylacrylamide; polyethylene-oxide-chain-containing vinyl compounds; hydroxyl-group-containing vinyl compounds; polyesters constituted by a polyfunctional carboxylic acid and a polyhydric alcohol; in particular, branched polyesters containing, as a component, a trifunctional or higher acid, e.g., trimellitic acid, and a large amount of terminal carboxylic acid or hydroxyl group; and polyesters containing a polyethylene glycol structure.

Examples of the hydrophobic monomer include monomers having a hydrophobic group. Specific examples thereof include olefins such as ethylene and butadiene; styrene derivatives such as styrene, α-methylstyrene, and vinyltoluene; vinylcyclohexane; vinylnaphthalene; vinylnaphthalene derivatives; vinyl acetate; alkyl acrylates; phenyl acrylate; alkyl methacrylates; phenyl methacrylate; cycloalkyl methacrylates; alkyl crotonates; dialkyl itaconates; dialkyl maleates; acrylonitrile; and derivatives thereof.

Specific examples of the water-absorbing resin which is a copolymer of a hydrophilic monomer and a hydrophobic monomer include (meth)acrylate copolymers such as styrene/alkyl (meth)acrylate/(meth) acrylic acid, styrene/(meth)acrylic acid/maleic acid (anhydride) copolymers, and olefin copolymers such as ethylene/propylene (modified products thereof and products in which a carboxylic acid unit is introduced by copolymerization), branched polyesters whose acid value is improved with trimellitic acid or the like, and polyamides.

The water-absorbing resin may contain, for example, a neutralized salt structure (e.g., carboxylate or the like). When the water-absorbing resin absorbs an ink containing a cation (such as a monovalent metal cation, e.g., cation of Na or Li), this neutralized salt structure of a carboxylic acid or the like interacts with the cation to form an ionomer.

The water-absorbing resin may contain a substituted or unsubstituted amino group or a substituted or unsubstituted pyridine group. These groups have an antiseptic effect or cause an interaction with a recording material (e.g., a pigment or a dye) having an anionic group.

The water-absorbing resin may have a straight-chain structure or a branched structure.

The water-absorbing resin preferably has a non-cross-linked or a slightly cross-linked structure from the standpoint of the image-fixing property.

The water-absorbing resin may be a random copolymer or block copolymer having a straight-chain structure or a polymer having a branched structure (including a random copolymer, block copolymer, or graft copolymer having a branched structure). For example, in the case of a polyester synthesized by polycondensation, a branched structure increases the number of terminal groups. Such a branched structure is generally obtained by adding a so-called cross-linking agent such as divinylbenzene or a di(meth)acrylate in the synthesis (for example, in an amount of less than 1%) or adding a large amount of initiator together with a cross-linking agent.

The acid value of the water-absorbing resin may be, for example, 50 mgKOH/g or more and 777 mgKOH/g or less in terms of carboxylic acid group (—COOH). The acid value in terms of carboxylic acid group (—COOH) is measured by the following method.

The acid value is measured by a neutralization titration method in accordance with JIS K0070. Specifically, a proper amount of a sample is prepared, and 100 mL of a solvent (mixture of diethyl ether and ethanol) and several droplets of an indicator (phenolphthalein solution) are added thereto. The resulting mixture is sufficiently shaken in a water bath until the sample is dissolved. This solution is titrated with a 0.1 mol/L ethanol solution of potassium hydroxide, and the point at which the red color of the indicator continues for 30 seconds is determined as the end point. The acid value is calculated by the following equation:

A=(B×f×5.611)/S

wherein A represents the acid value, S represents the amount (g) of sample, B represents the amount (mL) of a 0.1 mol/L ethanol solution of potassium hydroxide used in the titration, and f represents a factor of the 0.1 mol/L ethanol solution of potassium hydroxide.

The water-absorbing resin may be subjected to ionic cross-linking by an ion supplied from the ink. Specifically, for example, in the case where the water-absorbing resin has a structural unit containing a carboxylic acid therein, i.e., in the case where the water-absorbing resin is a copolymer containing a carboxylic acid such as (meth)acrylic acid or maleic acid or a (branched) polyester having a carboxylic acid, ionic cross-linking, an acid-base interaction, or the like is caused by the carboxylic acid in the resin and an alkali metal cation, an alkaline earth metal cation, an organic amine-onium cation, or the like supplied from a liquid such as a water-based ink.

The content of the liquid-absorbing particles in the curable composition is preferably in a range from 10% by mass to 40% by mass or in a range from about 10% by mass to about 40% by mass. When the content of the liquid-absorbing particles in the curable composition is 10% by mass or more or about 10% by mass or more, the liquid-absorbing particles reliably absorb water in the ink and a high-definition image is obtained. When the content of the liquid-absorbing particles in the curable composition is 40% by mass or less or about 40% by mass or less, aggregation of the liquid-absorbing particles is suppressed, and a decrease in glossiness during storage is more effectively suppressed. From the above viewpoints, the content of the liquid-absorbing particles in the curable composition is more preferably in a range from 15% by mass to 40% by mass, and still more preferably in a range from 20% by mass to 35% by mass.

### —Dispersant—

The curable composition for image recording according to this exemplary embodiment may contain a dispersant in order to more stably disperse the liquid-absorbing particles in the curable material.

For example, surfactants used for dispersing a coloring material in a UV ink or the like are preferably used as the dispersant. An example of a commercially available dispersant is Solsperse. However, the dispersant is not limited thereto and different types of dispersants may also be used as long as a similar effect is achieved.

The content of the dispersant in the curable composition is preferably 0.1% by mass or more and 10% by mass or less. When the content of the dispersant in the curable composition is 0.1% by mass or more, the effect of improving dispersibility of the liquid-absorbing particles is achieved. When the content of the dispersant in the curable composition is 10% by mass or less, a decrease in the liquid-absorbing property and inhibition of curability may not occur. From the above viewpoints, the content of the dispersant in the curable composition is more preferably 0.2% by mass or more and 8% by mass or less and still more preferably 0.5% by mass or more and 5% by mass or less.

### Method for Producing Curable Composition for Image Recording

The method for producing a curable composition according to this exemplary embodiment is not particularly limited. Liquid-absorbing particles having the above-described average particle diameter and the shape are suitably prepared by emulsion polymerization in an aqueous solvent. Primary particles prepared by emulsion polymerization have an average particle diameter of about several hundred nanometers, and a narrow particle size distribution. In addition, the surfaces of the particles are substantially uniform and the shape of the particles is close to a spherical shape. Thus, liquid-absorbing particles that are dispersed in the curable material without aggregation are obtained by emulsion polymerization. Specifically, an example of the method includes preparing liquid-absorbing particles dispersed in an aqueous solvent, and mixing the liquid-absorbing particles dispersed in the aqueous solvent and a curable material that is curable by a stimulus from the outside without drying the liquid-absorbing particles.

### (Step of Preparing Liquid-Absorbing Particles)

Fundamentally, particles may be prepared by a method for producing a resin by a common emulsion polymerization method. Specifically, a liquid prepared by mixing a polymerizable monomer component containing a monomer having a hydrophilic functional group with a polymerization initiator is used as an oil phase, and the oil phase component is added in a nitrogen atmosphere to an aqueous phase prepared by dissolving an emulsifier in water. Heating is then performed to allow a polymerization reaction to proceed, and particles are formed in a state of being dispersed in water. In the case where the hydrophilic functional group is an acid such as a carboxylic acid or a sulfonic acid, a salt structure such as a carboxylate or a sulfonate is formed by adding a basic component to the particles in the dispersed state. Thus, the liquid-absorbing property of the resulting resin may be improved.

(Mixing step)

The liquid-absorbing particles dispersed in the aqueous solvent are mixed with a curable material that is curable by a stimulus from the outside without drying the liquid-absorbing particles. In this step, if the liquid-absorbing particles are dried by evaporating the solvent, the liquid-absorbing particles aggregate to each other. Therefore, the particles dispersed in water are moved in an energy-reactive monomer or prepolymer while maintaining the liquid state and dispersed. When the liquid-absorbing particles are dispersed in the energy-reactive monomer, prepolymer, or the like in this manner, it is desirable to add a dispersant so as to improve the dispersibility of the particles.

In an example of a specific method, a part of water serving as a solvent is volatilized to increase the particle concentration, and isopropyl alcohol (IPA) is added to the resulting dispersion. A part of water and IPA is further volatilized, and the dispersion is then charged in an energy-reactive monomer/prepolymer mixed liquid containing a dispersant dissolved therein. A shear stress is applied to the mixed liquid by external energy or the like to disperse the particles. Subsequently, the remaining water and IPA are volatilized to complete the dispersion of the particles in the energy-reactive monomer/prepolymer. Thus, a curable composition is obtained.

The method is not limited thereto, and any method may be employed as long as the liquid-absorbing particles are dispersed in an energy-reactive monomer/prepolymer and water in which the liquid-absorbing particles are originally dispersed is removed.

### Image Recording Apparatus

An image recording apparatus according to this exemplary embodiment includes an intermediate transfer body; a curable composition layer forming unit that forms a curable composition layer by supplying the curable composition for image recording according to this exemplary embodiment to the intermediate transfer body; an ink application unit that applies a water-based ink onto the curable composition layer; a transfer unit that transfers, to a recording medium, the curable composition layer to which the water-based ink is applied; and a stimulus supply unit that supplies a stimulus for curing a curable material in the curable composition layer.

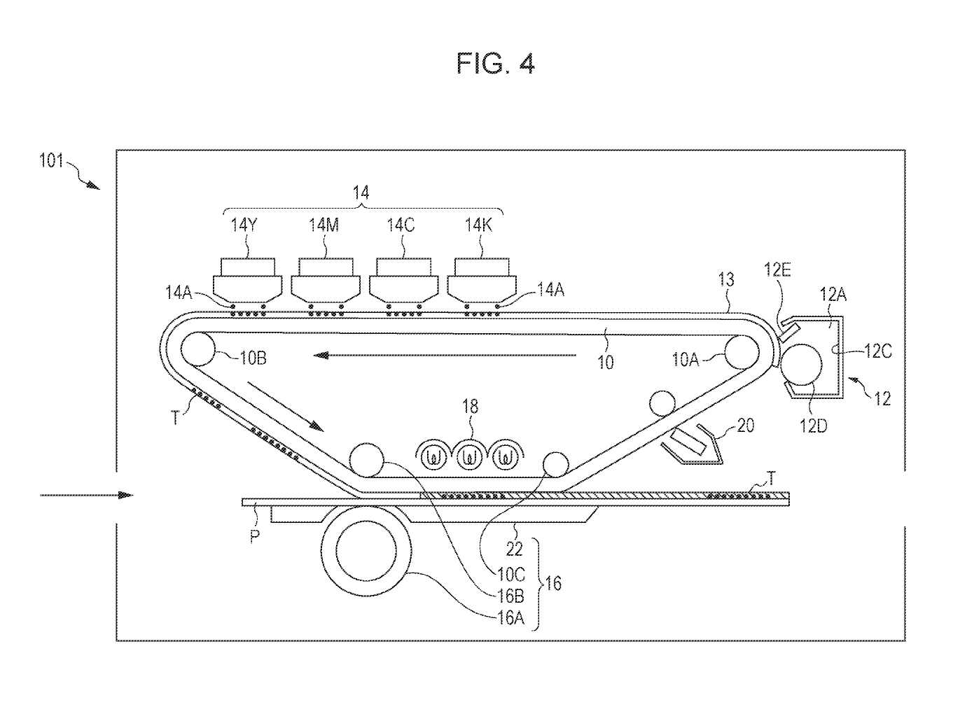

FIG. 4 schematically illustrates an example of the structure of an image recording apparatus according to this exemplary embodiment. An image recording apparatus 101 according to this exemplary embodiment includes an intermediate transfer belt 10 (an example of the intermediate transfer body), which is an endless belt. Around the intermediate transfer belt 10, from the upstream side of the moving direction (i.e., arrow direction) of the intermediate transfer belt 10, a curable composition layer forming device 12 (an example of the curable composition layer forming unit), an ink-jet recording head 14 (an example of the ink application unit), a transfer device 16 (an example of the transfer unit), and a cleaning device 20 are sequentially arranged. The curable composition layer forming device 12 supplies a curable composition 12A to the intermediate transfer belt 10 to form a curable composition layer 13. The ink-jet recording head 14 applies a water-based ink 14A to the curable composition layer 13 to form an image T. The transfer device 16 brings the curable composition layer 13, on which the image T is to be formed, into contact with a recording medium P and applies a pressure to transfer the curable composition layer 13, on which the image has been formed, to the recording medium P. The cleaning device 20 removes residues of the curable composition layer 13, the residues remaining on a surface of the intermediate transfer belt 10, and foreign matter (such as paper dust of the recording medium P) adhered to the surface.

The curable composition layer forming device 12 provides, as the curable composition 12A, a curable composition for image recording, the curable composition containing a curable material that is curable by a stimulus from the outside and liquid-absorbing particles that have a volume-average particle diameter in a range from 50 nm to 1,500 nm or in a range from about 50 nm to about 1,500 nm and a ratio volume-average particle diameter/number-average particle diameter in a range from 1.0 to 1.2 or in a range from about 1.0 to about 1.2 and that are dispersed in the curable material without aggregation.

A stimulus supply device 18 (an example of the stimulus supply unit) is provided inside the intermediate transfer belt 10. The stimulus supply device 18 supplies the curable composition layer 13 with a stimulus for curing the curable material contained in the curable composition layer 13 during contact between the curable composition layer 13 and the recording medium P, for example. The stimulus supply device 18 is arranged so as to face a region where the curable composition layer 13 contacts the recording medium P.

### (Intermediate Transfer Belt)

The intermediate transfer belt 10 is arranged, for example, in a supported manner so as to rotate while a tension is applied from the inner peripheral surface thereof by three support rolls 10A to 10C and a pressure roll 16B (transfer device 16). The intermediate transfer belt 10 has a width (length in the axial direction) equal to or larger than the width of the recording medium P.

Examples of the material of the intermediate transfer belt 10 include known materials that are generally used as an intermediate transfer belt, namely, various resins, various types of rubber, and metallic materials. The intermediate transfer belt 10 may have a single-layer structure or a laminated structure.

In this exemplary embodiment, since the stimulus supply device 18 is provided inside the intermediate transfer belt 10 as described above, a stimulus is supplied to the curable composition layer 13 after passing through the intermediate transfer belt 10. Accordingly, the intermediate transfer belt 10 preferably has stimulus permeability and stimulus resistance so as to supply the stimulus to the curable composition layer 13.

For example, in the case where the stimulus supply device 18 is an ultraviolet irradiation device, the intermediate transfer belt 10 preferably has permeability to ultraviolet rays and durability to ultraviolet rays. Specifically, for example, the intermediate transfer belt 10 preferably has an ultraviolet transmittance of 70% or more.

Specific examples of the material of the intermediate transfer belt 10 having permeability to ultraviolet rays and durability to ultraviolet rays include ethylene-tetrafluoroethylene (ETFE) copolymers, polyimide films, and polyolefin films.

The intermediate transfer belt 10 may have a surface releasing layer on a surface thereof, the surface contacting the curable composition layer 13. Examples of the material used as the surface releasing layer include fluorocarbon resin materials. Among these fluorocarbon resin materials, materials having permeability to the stimulus are preferably used. In the case where a material having low permeability to the stimulus is used, the thickness of the surface releasing layer may be reduced to the extent that the surface releasing layer exhibits permeability.

### (Curable Composition Layer Forming Device)

The curable composition layer forming device 12 includes, for example, a housing 12C containing the curable composition 12A therein. A supply roller 12D and a blade 12E are provided in the housing 12C. The supply roller 12D supplies the curable composition 12A to the intermediate transfer belt 10, and the blade 12E controls the amount of curable composition layer 13 formed of the supplied curable composition 12A.

The curable composition layer forming device 12 may be configured so that the supply roller 12D continuously contact the intermediate transfer belt 10 or the supply roller 12D is arranged to form a space between the supply roller 12D and the intermediate transfer belt 10. Alternatively, the curable composition layer forming device 12 may be configured so that an independent composition supply system (not shown) supplies the curable composition 12A to the housing 12C, thereby continuously supplying the curable composition 12A.

The structure of the curable composition layer forming device 12 is not limited thereto, and devices using a known supply method (coating method such as a die coating method, a bar coating method, a spray coating method, an ink-jet coating method, an air-knife coating method, a blade coating method, or a roll coating method) may be used.

### (Ink-Jet Recording Head)

The ink-jet recording head 14 includes, for example, recording heads of respective colors, namely, from the upstream side of a moving direction of the intermediate transfer belt 10, a recording head 14K for applying a black ink, a recording head 14C for applying a cyan ink, a recording head 14M for applying a magenta ink, and a recording head 14Y for applying a yellow ink. The structure of the recording head 14 is not limited to the above structure. For example, the recording head 14 may include only the recording head 14K. Alternatively, the recording head 14 may include only one of the recording head 14C, the recording head 14M, and the recording head 14Y.

Each recording head 14 is arranged on a non-curved region of the intermediate transfer belt 10 that is supported in a rotatable manner while a tension is applied so that the distance between a surface of the intermediate transfer belt 10 and a nozzle surface of the recording head 14 is, for example, 0.7 to 1.5 mm.

Each recording head 14 is preferably a line-type ink-jet recording head having a width equal to or larger than the width of the recording medium P. Alternatively, an existing scanning-type ink-jet recording head may also be used.

The method for applying an ink of each recording head 14 is not particularly limited as long as the ink 14A is applied. Examples thereof include a piezoelectric element driving method and a heater element driving method.

An ink containing an aqueous solvent as a solvent is used as the water-based ink 14A. An example of the water-based ink is an ink obtained by dispersing or dissolving a water-soluble dye or pigment as a recording material in an aqueous solvent. The composition of the water-based ink 14A is not particularly limited, and water-based inks having known compositions may be used.

### (Transfer Device)

The transfer device 16 supports the intermediate transfer belt 10 using the pressure roll 16B and the support roll 10C with a tension to form a non-curved region. In the non-curved region of the intermediate transfer belt 10, a support 22 that supports the recording medium P is provided at a position facing the pressure roll 16B and the support roll 10C. A pressure roll 16A is arranged at a position facing the pressure roll 16B, with the intermediate transfer belt 10 therebetween, and contacts the recording medium P through an opening provided in the support 22.

That is, in a transfer region extending from a position at which the intermediate transfer belt 10 and the recording medium P are sandwiched between the pressure rolls 16A and 16B (hereinafter may be referred to as “contact starting position”) to a position at which the intermediate transfer belt 10 and the recording medium P are sandwiched between the support roll 10C and the support 22 (hereinafter may be referred to as “separating position”), the curable composition layer 13 is in contact with the intermediate transfer belt 10 and the recording medium P.

### (Stimulus Supply Device)

The stimulus supply device 18 is provided inside the intermediate transfer belt 10 and supplies a stimulus to the curable composition layer 13 that is in contact with the intermediate transfer belt 10 and the recording medium P through the intermediate transfer belt 10 in the transfer region.

The type of stimulus supply device 18 is selected in accordance with the type of curable material contained in the curable composition 12A used. For example, in the case where an ultraviolet-curable material that is curable by irradiation of ultraviolet rays is used, an ultraviolet irradiation device that irradiates the curable composition 12A (the curable composition layer 13 formed by using the curable composition 12A) with ultraviolet rays is used as the stimulus supply device 18.

In the case where an electron-beam-curable material that is curable by irradiation of an electron beam is used, an electron-beam irradiation device that irradiates the curable composition 12A (the curable composition layer 13 formed by using the curable composition 12A) with an electron beam is used as the stimulus supply device 18.

In the case where a thermosetting material that is curable by application of heat is used, a heat application device that applies heat to the curable composition 12A (the curable composition layer 13 formed by using the curable composition 12A) is used as the stimulus supply device 18.

Examples of the ultraviolet irradiation device include a metal halide lamp, a high-pressure mercury-vapor lamp, an ultra-high-pressure mercury-vapor lamp, a deep ultraviolet lamp, a lamp that externally excites a mercury-vapor lamp with microwaves without using an electrode, ultraviolet laser, a xenon lamp, and a UV-LED lamp.

The conditions for irradiation with ultraviolet rays are not particularly limited and may be selected in accordance with the type of ultraviolet-curable material, the thickness of the curable composition layer 13, etc. For example, in the case where a metal halide lamp is used, irradiation may be conducted at an integrated light quantity of 20 mJ/cm² or more and 1,000 mJ/cm² or less.

Examples of the electron-beam irradiation device include a scan-type device and a curtain-type device. The curtain-type electron-beam irradiation device is a device in which thermoelectrons generated in a filament are led by a grid in a vacuum chamber and are accelerated by a high voltage (for example, 70 to 300 kV) at a time to form an electron flow, and the electron flow passes through a window foil and is discharged into the atmosphere. The wavelength of the electron beams is generally less than 1 nm, and the energy of the electron beams may be up to several MeVs. However, an electron beam having a wavelength on the order of pm and an energy of several tens of keV or more and several hundreds keV or less is used.

The conditions for irradiation with an electron beam are not particularly limited and may be selected in accordance with the type of electron-beam-curable material, the thickness of the curable composition layer 13, etc. For example, irradiation may be conducted at an electron beam dose of 5 kGy or more and 100 kGy or less.

Examples of the heat application device include a halogen lamp, a ceramic heater, a nichrome wire heater, a microwave heater, and an infrared-ray lamp. A heat application device employing an electromagnetic induction method may also be used.

The conditions for applying heat are not particularly limited and may be selected in accordance with the type of thermosetting material, the thickness of the curable composition layer 13, etc. For example, the application of heat may be conducted at 200° C. for 5 minutes in air.

### (Recording Medium)

The recording medium P may be either a permeable medium (for example, plain paper, coated paper, or the like) or a non-permeable medium (for example, art paper, a resin film, or the like). However, the recording medium P is not limited thereto and may be other industrial products such as a semiconductor substrate.

### Method for Recording Image

A method for recording an image according to this exemplary embodiment includes forming a curable composition layer by supplying the above-described curable composition for image recording to an intermediate transfer body; applying a water-based ink onto the curable composition layer; transferring, to a recording medium, the curable composition layer to which the water-based ink is applied; and supplying a stimulus for curing a curable material in the curable composition layer.

A method for recording an image using the image recording apparatus 101 will now be described as an example of the method for recording an image according to this exemplary embodiment.

In the image recording apparatus 101 according to this exemplary embodiment, the intermediate transfer belt 10 is rotated, and, first, the curable composition 12A is supplied to a surface of the intermediate transfer belt 10 by the curable composition layer forming device 12 to form a curable composition layer 13.

The thickness (average thickness) of the curable composition layer 13 is set so as to be larger than the volume-average particle diameter of liquid-absorbing particles contained in the curable composition used in this exemplary embodiment. The thickness of the curable composition layer 13 is preferably double or more of the volume-average particle diameter of the liquid-absorbing particles. When the thickness of the curable composition layer 13 is double or more of the volume-average particle diameter of the liquid-absorbing particles, arrival of the water-based ink 14A to the bottom of the curable composition layer 13 is suppressed, and exposure of the liquid-absorbing particles to a surface of the curable composition layer 13 is effectively suppressed. From the above viewpoint, the thickness of the curable composition layer 13 is more preferably three times or more and particularly preferably five times or more the volume-average particle diameter of the liquid-absorbing particles.

More specifically, the thickness (average thickness) of the curable composition layer 13 is preferably 5 μm or more and 50 μm or less and more preferably 8 μm or more and 35 μm or less, though it depends on the volume-average particle diameter of the liquid-absorbing particles contained in the curable composition. When the thickness of the curable composition layer 13 is 50 μm or less, the curable composition layer 13 has good bending resistance, and the material cost is also effectively reduced.

Furthermore, for example, when the thickness of the curable composition layer 13 is set so that the water-based ink 14A does not reach the bottom of the curable composition layer 13, after transferring of the curable composition layer 13 to the recording medium P, a region of the curable composition layer 13 where the water-based ink 14A is present is not exposed and a region of the curable composition layer 13 where the water-based ink 14A is not present functions as a protective layer.

Next, the water-based ink 14A is applied to the curable composition layer 13 by the ink-jet recording head 14. On the basis of image information, the ink-jet recording head 14 applies the water-based ink 14A to a region of the curable composition layer 13 where an image is to be formed.

In this step, the application of the water-based ink 14A by the ink-jet recording head 14 is performed, for example, on the non-curved region of the intermediate transfer belt 10, which is supported in a rotatable manner while a tension is applied. Specifically, the water-based ink 14A is applied onto the curable composition layer 13 while deflection of the surface of the intermediate transfer belt 10 is suppressed.

Next, the recording medium P and the intermediate transfer belt 10 are sandwiched between the pressure rolls 16A and 16B of the transfer device 16 to apply a pressure. At this time, the curable composition layer 13 on the intermediate transfer belt 10 contacts the recording medium P (contact starting position). Thereafter, the state where the curable composition layer 13 is in contact with both the intermediate transfer belt 10 and the recording medium P is maintained to a position (separating position) at which the recording medium P and the intermediate transfer belt 10 are sandwiched between the support roll 10C and the support 22.

In this case, the pressure applied to the curable composition layer 13 by the pressure rolls 16A and 16B is, for example, preferably 0.001 MPa or more and 2 MPa or less and more preferably 0.001 MPa or more and 0.5 MPa or less.

Next, a stimulus is supplied by the stimulus supply device 18 to the curable composition layer 13 that is in contact with (during contact with) both the intermediate transfer belt 10 and the recording medium P through the intermediate transfer belt 10. Thus, the curable composition layer 13 is cured. Specifically, the supply of the stimulus is started after the curable composition layer 13 on the intermediate transfer belt 10 has contacted the recording medium P (after the curable composition layer 13 on the intermediate transfer belt 10 has passed through the contact starting position), and the supply of the stimulus is terminated before the curable composition layer 13 is separated from the intermediate transfer belt 10 (before the curable composition layer 13 reaches the separating position).

The amount of stimulus supplied is preferably such an amount that the curable composition layer 13 is cured to the extent that the curable composition layer 13 is easily separated from the intermediate transfer belt 10. Specifically, for example, in the case where the stimulus is ultraviolet rays, the amount of stimulus is preferably 10 mJ/cm² or more and 1,000 mJ/cm² or less in terms of integrated light quantity.

Next, the curable composition layer 13 is separated from the intermediate transfer belt 10 at the separating position. Thus, a curable resin layer (image layer) including an image T formed by the water-based ink 14A is formed on the recording medium P.

Subsequently, residues of the curable composition layer 13 and foreign matter that remain on the surface of the intermediate transfer belt 10 after the curable composition layer 13 has been transferred to the recording medium P are removed are removed by the cleaning device 20. The curable composition 12A is again supplied to the intermediate transfer belt 10 by the curable composition layer forming device 12 to form a curable composition layer 13, thus repeating the image recording process.

In the image recording apparatus 101 according to this exemplary embodiment in which image recording is conducted through the above steps, when the water-based ink 14A is applied onto the curable composition layer 13, for example, a liquid component (water component) of the water-based ink 14A is absorbed in a water-absorbing component (liquid-absorbing particles) contained in the curable composition layer 13, and a residual component containing a recording material (e.g., coloring material) adheres around the water-absorbing component, thus forming the image T. Subsequently, in this state, the curable composition layer 13 having the image T thereon is transferred to the recording medium P and cured, thus obtaining an image-recorded matter (image-recorded matter including a recording medium and a cured layer retaining an image).

In the image recording apparatus 101 according to this exemplary embodiment, the supply of the stimulus is started after the curable composition layer 13 has passed through the contact starting position, and the supply of the stimulus is terminated before the curable composition layer 13 reaches the separating position, as described above. However, the supply of the stimulus is not limited thereto.

For example, the supply of the stimulus may be started at the time when the curable composition layer 13 passes through the contact starting position. Alternatively, the supply of the stimulus may be started before the curable composition layer 13 passes through the contact starting position. In addition, for example, the supply of the stimulus may be terminated at the time when the curable composition layer 13 reaches the separating position. Alternatively, the supply of the stimulus may be terminated after the curable composition layer 13 has passed through the separating position. Furthermore, during the time from the start to the termination of the supply of the stimulus, the supply of the stimulus may be temporarily stopped and may then be started again. In addition, the supply of the stimulus may be conducted after the curable composition layer 13 is transferred to the recording medium P.

In the image recording apparatus 101 according to this exemplary embodiment, the stimulus supply device 18 is arranged inside the intermediate transfer belt 10, and the stimulus is supplied to the curable composition layer 13 after passing through the intermediate transfer belt 10, as described above. However, the arrangement of the stimulus supply device 18 is not limited thereto.

Specifically, for example, the stimulus supply device 18 may be arranged outside the intermediate transfer belt 10, and the stimulus may be supplied to the curable composition layer 13 on the intermediate transfer belt 10 directly (or after passing through the support 22 and the recording medium P) without passing through the intermediate transfer belt 10.

Alternatively, for example, a body of the stimulus supply device 18 may be arranged outside the intermediate transfer belt 10, and a stimulus passing through the intermediate transfer belt 10 may be supplied to the curable composition layer 13.

Specifically, for example, in the case where the stimulus supply device 18 is an ultraviolet irradiation device, a body of the ultraviolet irradiation device may be arranged outside the intermediate transfer belt 10, ultraviolet rays may be led from the body of the ultraviolet irradiation device to the inside of the intermediate transfer belt 10 using an optical fiber or the like, and the curable composition layer 13 may be irradiated with ultraviolet rays that has passed through the intermediate transfer belt 10.

Furthermore, for example, an intermediate transfer drum may be arranged instead of the intermediate transfer belt 10.

In the image recording apparatus 101 of this exemplary embodiment, a water-based ink 14A is selectively applied from the ink-jet recording head 14 including recording heads of respective colors of black, yellow, magenta, and cyan on the basis of image data, and a color image is recorded on the recording medium P. Alternatively, an image may be recorded using a single color of ink. Furthermore, the recording is not limited to recording of letters and the like on a recording medium. The image recording apparatus 101 may be applied to, for example, liquid droplet applying (ejecting) apparatuses that are industrially used.

### EXAMPLES

The present invention will now be specifically described by way of Examples. However, these Examples do not limit the present invention.

An image is recorded using the image recording apparatus 101 having the structure illustrated in FIG. 4.

First, a curable composition 12A is supplied to the intermediate transfer belt 10 by the curable composition layer forming device 12 to form a curable composition layer 13. Next, water-based inks of respective colors are applied onto the curable composition layer 13 by the ink-jet recording head 14 (including 14K, 14C, 14M, and 14Y) to from an image. Next, a stimulus is supplied by the stimulus supply device 18 while the curable composition layer 13 is brought into contact with a recording medium P by the transfer device 16 to cure the curable composition layer 13. The resulting image-recorded matter is separated from the intermediate transfer belt 10 and evaluated.

Recording medium P: A plain paper (C2 manufactured by Fuji Xerox InterField Co., Ltd.)

Printing pattern: J6 chart (Japan Electronics and Information Technology Industries Association (JEITA) standard pattern)

The following curable compositions and water-based inks of respective colors are used.

### (Water-Based Inks)

### —Black Ink—

C.I. Direct Black 154: 4 parts by weight

Propylene glycol: 5 parts by weight

2-Pyrrolidone: 5 parts by weight

Glycerin: 15 parts by weight

Olfine E1010 (manufactured by Nissin Chemical Industry Co., Ltd.): 2.0 parts by weight

Pure water: 70 parts by weight

The above composition is mixed, and the pH of the resulting mixture is adjusted by further adding sodium hydroxide (NaOH). The mixture is then filtered with a 0.45-μm filter to obtain a black ink.

### —Cyan Ink—

C.I. Direct Blue 199: 3.5 parts by weight

Diethylene glycol: 15 parts by weight

Propylene glycol: 10 parts by weight

Tetraethylene glycol: 5 parts by weight

Surfynol 465 (manufactured by Nissin Chemical Industry Co., Ltd.): 2.0 parts by weight

Pure water: 65 parts by weight

The above composition is mixed, and the pH of the resulting mixture is adjusted by further adding NaOH. The mixture is then filtered with a 0.45-μm filter to obtain a cyan ink.

### —Magenta Ink—

C.I. Direct Red 70: 3 parts by weight

Diethylene glycol: 10 parts by weight

Glycerin: 10 parts by weight

Dipropylene glycol: 4 parts by weight

Diethylene glycol monobutyl ether: 3.5 parts by weight

Olfine E1010 (manufactured by Nissin Chemical Industry Co., Ltd.): 1.5 parts by weight

Pure water: 70 parts by weight

The above composition is mixed, and the pH of the resulting mixture is adjusted by further adding NaOH. The mixture is then filtered with a 0.45-μm filter to obtain a magenta ink.

### —Yellow Ink—

C.I. Direct Yellow 132: 3 parts by weight

Polyethylene glycol 400: 10 parts by weight

2-Pyrrolidone: 5 parts by weight

Glycerin: 7 parts by weight

Oxyethylene stearyl ether: 1.0 part by weight

Oxyethylene oxypropylene block polymer: 1.0 part by weight

Pure water: 70 parts by weight

The above composition is mixed, and the pH of the resulting mixture is adjusted by further adding NaOH. The mixture is then filtered with a 0.45-μm filter to obtain a yellow ink.

### Example 1

Synthesis is conducted using styrene, butyl methacrylate, and mono-2-(methacryloyloxy)ethyl phthalate monomers by emulsion polymerization in water to prepare an aqueous emulsion of a copolymerized polymer. Specifically, the synthesis is conducted using the following composition under the conditions below.

A liquid is prepared by mixing styrene, butyl methacrylate, and mono-2-(methacryloyloxy)ethyl phthalate in a molar ratio of styrene:butyl methacrylate:mono-2-(methacryloyloxy)ethyl phthalate=1:3:6, divinylbenzene functioning as a cross-linking agent in an amount corresponding to 0.1 moles, and potassium persulfate functioning as a polymerization initiator. The resulting mixed liquid is put in a 0.25% aqueous sodium dialkyl sulfosuccinate solution purged with nitrogen. The system is maintained at 60° C. in a nitrogen atmosphere, and stirring is continued for 16 hours to obtain an aqueous polymer emulsion.

This aqueous polymer emulsion is used after being neutralized by adding NaOH. Particles in the neutralized aqueous polymer emulsion are transferred from the water solvent to a mixed solvent of water and isopropyl alcohol (IPA), and further transferred to an ultraviolet-curable material having the composition described below and mixed. Thus, an ultraviolet-curable composition in which the liquid-absorbing particles are dispersed in the ultraviolet-curable material without aggregation is prepared.

The weight ratio of the liquid-absorbing particles contained in the prepared ultraviolet-curable composition is 20% by weight.

The volume-average particle diameter (Mv) and the ratio (Mv/Mn) of the volume-average particle diameter to the number-average particle diameter are measured using a dynamic light-scattering particle diameter/particle size distribution analyzer Nanotrac UPA (manufactured by Nikkiso Co., Ltd.). Furthermore, the ratio of the maximum distance of surface irregularities to the particle diameter is calculated using a TEM image. The measurement results are as follows.

Mv=640 nm

Mv/Mn=1.09

Ratio of maximum distance of surface irregularities to particle diameter=0.5%

### (Ultraviolet-Curable Material)

Polyurethane acrylate: 20 parts by mass

Acryloylmorpholine: 10 parts by mass

Urethane prepolymer having an isocyanurate ring: 25 parts by mass

Trimethylolpropane ethoxy triacrylate: 40 parts by mass

Silicone-modified polyether acrylate: 5 parts by mass

IRGACURE 819 (Photopolymerization initiator): 4 parts by mass

The ultraviolet-curable composition prepared above is supplied to an intermediate transfer belt by a curable composition layer forming device to form an ultraviolet-curable composition layer. Next, inks of respective colors are applied onto the ultraviolet-curable composition layer using an ink-jet head to form an image. The ultraviolet-curable composition layer is then irradiated with a UV-LED lamp (manufactured by Nichia Corporation, Light-emitting diode NCCU033, peak wavelength: 365 nm) while bringing the ultraviolet-curable composition layer into contact with a recording medium by using a transfer device, thereby curing the ultraviolet-curable composition layer. The cured layer is separated from the intermediate transfer belt and transferred to the recording medium. The thickness of the cured layer transferred to the recording medium is 10 μm.

### (Evaluation)

—Glossiness-Maintaining Property—

A water droplet is dropped on a non-printed portion of the recorded image, and is then wiped off. The portion where the water droplet is dropped and then wiped off is compared with another non-printed portion. In the portion where the water droplet is dropped and then wiped off, the glossiness at an angle of incidence of 60° is 95. In the other non-printed portion where no water droplet is dropped, the glossiness at an angle of incidence of 60° is 96. Accordingly, there is no substantial difference in glossiness between these two portions, and thus degradation of the image quality is not observed.

### —Image Quality—

To evaluate the image quality, a one-dot line is printed and the occurrence of bleeding is examined. According to the result, a high-definition image without defects is obtained.

### Example 2

Particles obtained as in Example 1 are transferred from a water solvent to a mixed solvent of water and IPA, and further transferred to an ultraviolet-curable material having the composition described below, thus preparing a ultraviolet-curable composition in which the liquid-absorbing particles in a non-aggregated state are dispersed in the ultraviolet-curable material. The weight ratio of the particles contained in the ultraviolet-curable composition is 30% by weight.

(Ultraviolet-curable material)

Polyurethane acrylate: 25 parts by mass

Hydroxyethyl acrylamide: 10 parts by mass

Polyethylene glycol 400 diacrylate: 15 parts by mass

Glycerin propoxy acrylate: 35 parts by mass

Silicone-modified polyether acrylate: 5 parts by mass

Solsperse 24000 (dispersant): 5 parts by mass

IRGACURE 754 (Photopolymerization initiator): 5 parts by mass

The ultraviolet-curable composition prepared above is supplied to an intermediate transfer belt by a curable composition layer forming device to form an ultraviolet-curable composition layer. Next, inks of respective colors are applied onto the ultraviolet-curable composition layer using an ink-jet head to form an image. The ultraviolet-curable composition layer is then irradiated with a UV-LED lamp while bringing the ultraviolet-curable composition layer into contact with a recording medium by using a transfer device, thereby curing the ultraviolet-curable composition layer. The cured layer is separated from the intermediate transfer belt and transferred to the recording medium. The thickness of the cured layer transferred to the recording medium is 20 μm.

### (Evaluation)

A water droplet is dropped on a non-printed portion of the recorded image, and is then wiped off. The portion where the water droplet is dropped and then wiped off is compared with another non-printed portion. In the portion where the water droplet is dropped and then wiped off, the glossiness at an angle of incidence of 60° is 97. In the other non-printed portion where no water droplet is dropped, the glossiness at an angle of incidence of 60° is 98. Accordingly, there is no substantial difference in glossiness between these two portions, and thus degradation of the image quality is not observed.

To evaluate the image quality, a one-dot line is printed and the occurrence of bleeding is examined. A high-definition image without defects is obtained.

### Example 3

Synthesis is conducted using styrene, butyl methacrylate, and methacrylic acid monomers by emulsion polymerization in water as in Example 1 except that a 0.5% aqueous sodium lauryl sulfonate solution is used instead of the aqueous sodium dialkyl sulfosuccinate solution of Example 1 to prepare an aqueous emulsion of a copolymerized polymer. This aqueous polymer emulsion is used after being neutralized by adding NaOH. Particles in the neutralized aqueous polymer emulsion are transferred from the water solvent to a mixed solvent of water and IPA, and further transferred to an ultraviolet-curable material having the composition described below. Thus, an ultraviolet-curable composition in which the liquid-absorbing particles in a non-aggregated state are dispersed in the ultraviolet-curable material is prepared. The weight ratio of the particles contained in the ultraviolet-curable composition is 20% by weight.

The volume-average particle diameter (Mv) and the ratio (Mv/Mn) of the volume-average particle diameter to the number-average particle diameter are measured using Nanotrac UPA. The ratio of the maximum distance of surface irregularities to the particle diameter is calculated using a TEM image.

Mv=55 nm

Mv/Mn=1.14

Ratio of maximum distance of surface irregularities to particle diameter=0.3%

### (Ultraviolet-Curable Material)

Polyurethane acrylate: 30 parts by mass

Polyethylene glycol 600 diacrylate: 10 parts by mass

Aliphatic diacrylate having an isocyanurate ring: 20 parts by mass

Pentaerythritol triacrylate: 25 parts by mass

Silicone-modified polyether acrylate: 5 parts by mass

IRGACURE 184 (Photopolymerization initiator): 5 parts by mass

The ultraviolet-curable composition prepared above is supplied to an intermediate transfer belt by an ultraviolet curable composition layer forming device to form an ultraviolet-curable composition layer. Next, inks of respective colors are applied onto the ultraviolet-curable composition layer using an ink-jet head to form an image. The ultraviolet-curable composition layer is then irradiated with a UV metal halide lamp while bringing the ultraviolet-curable composition layer into contact with a recording medium by using a transfer device, thereby curing the ultraviolet-curable composition layer. The cured layer is separated from the intermediate transfer belt and transferred to the recording medium. The thickness of the cured layer transferred to the recording medium is 8 μm.

### (Evaluation)

A water droplet is dropped on a non-printed portion of the recorded image, and is then wiped off. The portion where the water droplet is dropped and then wiped off is compared with another non-printed portion. In the portion where the water droplet is dropped and then wiped off, the glossiness at an angle of incidence of 60° is 93. In the other non-printed portion where no water droplet is dropped, the glossiness at an angle of incidence of 60° is 95. Accordingly, there is no substantial difference in glossiness between these two portions, and thus degradation of the image quality is not observed.

To evaluate the image quality, a one-dot line is printed and the occurrence of bleeding is examined. A high-definition image without defects is obtained.

### Example 4

Synthesis is conducted by emulsion polymerization in water as in Example 1 except that styrene, butyl methacrylate, and mono-2-(methacryloyloxy)ethyl phthalate monomers are used in a molar ratio of styrene:butyl methacrylate:mono-2-(methacryloyloxy)ethyl phthalate=1:1:8, and divinylbenzene functioning as a cross-linking agent is used in an amount corresponding to 0.02 moles to prepare an aqueous emulsion of a copolymerized polymer. This aqueous polymer emulsion is used after being neutralized by adding NaOH. Particles in the neutralized aqueous polymer emulsion are transferred from the water solvent to a mixed solvent of water and IPA, and further transferred to an ultraviolet-curable material having the composition described below. Thus, an ultraviolet-curable composition in which the liquid-absorbing particles in a non-aggregated state are dispersed in the ultraviolet-curable material is prepared. The weight ratio of the particles contained in the ultraviolet-curable composition is 25% by weight.

The volume-average particle diameter (Mv) and the ratio (Mv/Mn) of the volume-average particle diameter to the number-average particle diameter are measured using Nanotrac UPA. The ratio of the maximum distance of surface irregularities to the particle diameter is calculated using a TEM image.

Mv=1,150 nm

Mv/Mn=1.11

Ratio of maximum distance of surface irregularities to particle diameter=0.8%

### (Ultraviolet-Curable Material)

Polyurethane acrylate: 35 parts by mass

Acryloylmorpholine: 10 parts by mass

Aliphatic diacrylate having an isocyanurate ring: 15 parts by mass

Tripropylene glycol diacrylate: 27 parts by mass

Silicone-modified polyether acrylate: 3 parts by mass

Solsperse 32000 (dispersant): 5 parts by mass

IRGACURE 127 (Photopolymerization initiator): 5 parts by mass

The ultraviolet-curable composition prepared above is supplied to an intermediate transfer belt by a curable composition layer forming device to form an ultraviolet-curable composition layer. Next, inks of respective colors are applied onto the ultraviolet-curable composition layer using an ink-jet head to form an image. The ultraviolet-curable composition layer is then irradiated with a high-pressure mercury-vapor lamp while bringing the ultraviolet-curable composition layer into contact with a recording medium by using a transfer device, thereby curing the ultraviolet-curable composition layer. The cured layer is separated from the intermediate transfer belt and transferred to the recording medium. The thickness of the cured layer transferred to the recording medium is 25 μm.

### (Evaluation)

A water droplet is dropped on a non-printed portion of the recorded image, and is then wiped off. The portion where the water droplet is dropped and then wiped off is compared with another non-printed portion. In the portion where the water droplet is dropped and then wiped off, the glossiness at an angle of incidence of 60° is 90. In the other non-printed portion where no water droplet is dropped, the glossiness at an angle of incidence of 60° is 97. Although there is a slight difference in glossiness between these two portions, there is no substantial difference in visual observation and thus degradation of the image quality is not observed.

To evaluate the image quality, a one-dot line is printed and the occurrence of bleeding is examined. A high-definition image without defects is obtained.

### Example 5

Synthesis is conducted by emulsion polymerization in water as in Example 1 except that styrene, butyl methacrylate, and methacrylic acid monomers are used in a molar ratio of styrene:butyl methacrylate:methacrylic acid=1:4:5 to prepare an aqueous emulsion of a copolymerized polymer. This aqueous polymer emulsion is used after being neutralized by adding NaOH. Particles in the neutralized aqueous polymer emulsion are transferred from the water solvent to a mixed solvent of water and IPA, and further transferred to an ultraviolet-curable material having the composition described below. Thus, an ultraviolet-curable composition in which the liquid-absorbing particles in a non-aggregated state are dispersed in the ultraviolet-curable material is prepared. The weight ratio of the particles contained in the ultraviolet-curable composition is 22% by weight.

The volume-average particle diameter (Mv) and the ratio (Mv/Mn) of the volume-average particle diameter to the number-average particle diameter are measured using Nanotrac UPA. The ratio of the maximum distance of surface irregularities to the particle diameter is calculated using a TEM image.

Mv=650 nm

Mv/Mn=1.19

Ratio of maximum distance of surface irregularities to particle diameter=1.2%

### (Ultraviolet-Curable Material)

Polyurethane acrylate: 20 parts by mass

Acryloylmorpholine: 10 parts by mass

Urethane prepolymer having an isocyanurate ring: 25 parts by mass

Trimethylolpropane ethoxy triacrylate: 40 parts by mass

Silicone-modified polyether acrylate: 5 parts by mass

IRGACURE 819 (Photopolymerization initiator): 4 parts by mass

The ultraviolet-curable composition prepared above is supplied to an intermediate transfer belt by a curable composition layer forming device to form an ultraviolet-curable composition layer. Next, inks of respective colors are applied onto the ultraviolet-curable composition layer using an ink-jet head to form an image. The ultraviolet-curable composition layer is then irradiated with a metal halide lamp while bringing the ultraviolet-curable composition layer into contact with a recording medium by using a transfer device, thereby curing the ultraviolet-curable composition layer. The cured layer is separated from the intermediate transfer belt and transferred to the recording medium. The thickness of the cured layer transferred to the recording medium is 15 μm.

### (Evaluation)

A water droplet is dropped on a non-printed portion of the recorded image, and is then wiped off. The portion where the water droplet is dropped and then wiped off is compared with another non-printed portion. In the portion where the water droplet is dropped and then wiped off, the glossiness at an angle of incidence of 60° is 95. In the other non-printed portion where no water droplet is dropped, the glossiness at an angle of incidence of 60° is 97. Accordingly, there is no substantial difference in glossiness between these two portions, and thus degradation of the image quality is not observed.

To evaluate the image quality, a one-dot line is printed and the occurrence of bleeding is examined. Although defects are slightly observed, a high-definition image is obtained.

### Example 6

Synthesis is conducted by emulsion polymerization in water as in Example 1 except that styrene, butyl methacrylate, and acrylic acid monomers are used in a molar ratio of styrene:butyl methacrylate:acrylic acid=1:5:4, and divinylbenzene functioning as a cross-linking agent is used in an amount corresponding to 0.05 moles to prepare an aqueous emulsion of a copolymerized polymer. This aqueous polymer emulsion is used after being neutralized by adding NaOH. Particles in the neutralized aqueous polymer emulsion are transferred from the water solvent to a mixed solvent of water and IPA, and further transferred to an ultraviolet-curable material having the composition described below. Thus, an ultraviolet-curable composition in which the liquid-absorbing particles in a non-aggregated state are dispersed in the ultraviolet-curable material is prepared. The weight ratio of the particles contained in the ultraviolet-curable composition is 25% by weight.

The volume-average particle diameter (Mv) and the ratio (Mv/Mn) of the volume-average particle diameter to the number-average particle diameter are measured using Nanotrac UPA. The ratio of the maximum distance of surface irregularities to the particle diameter is calculated using a TEM image.

Mv=950 nm

Mv/Mn=1.12

Ratio of maximum distance of surface irregularities to particle diameter=4.8%

### (Ultraviolet-Curable Material)

Polyurethane acrylate: 20 parts by mass

Polyethylene glycol 600 diacrylate: 14 parts by mass

Urethane prepolymer having an isocyanurate ring: 25 parts by mass

Neopentylglycol diacrylate: 25 parts by mass

Silicone-modified polyether acrylate: 4 parts by mass

Solsperse 36000 (dispersant): 3 parts by mass

LUCIRIN TPO (Photopolymerization initiator): 4 parts by mass

The ultraviolet-curable composition prepared above is supplied to an intermediate transfer belt by a curable composition layer forming device to form an ultraviolet-curable composition layer. Next, inks of respective colors are applied onto the ultraviolet-curable composition layer using an ink-jet head to form an image. The ultraviolet-curable composition layer is then irradiated with a metal halide lamp while bringing the ultraviolet-curable composition layer into contact with a recording medium by using a transfer device, thereby curing the ultraviolet-curable composition layer. The cured layer is separated from the intermediate transfer belt and transferred to the recording medium. The thickness of the cured layer transferred to the recording medium is 18 μm.

### (Evaluation)

A water droplet is dropped on a non-printed portion of the recorded image, and is then wiped off. The portion where the water droplet is dropped and then wiped off is compared with another non-printed portion. In the portion where the water droplet is dropped and then wiped off, the glossiness at an angle of incidence of 60° is 89. In the other non-printed portion where no water droplet is dropped, the glossiness at an angle of incidence of 60° is 97. Although there is a slight difference in glossiness between these two portions, there is no substantial difference in visual observation and thus degradation of the image quality is not observed.

To evaluate the image quality, a one-dot line is printed and the occurrence of bleeding is examined. A high-definition image without defects is obtained.

### COMPARATIVE EXAMPLE 1

An aqueous polymer emulsion prepared as in Example 1 is dried with a spray dryer to obtain aggregate particles formed by aggregation of liquid-absorbing particles. The liquid-absorbing particles (aggregate particles) are dispersed in an ultraviolet-curable material having the same composition as that of Example 1 to prepare an ultraviolet-curable composition. The weight ratio of the particles contained in the ultraviolet-curable composition is 25% by weight.

The volume-average particle diameter (Mv) and the ratio (Mv/Mn) of the volume-average particle diameter to the number-average particle diameter are measured using Microtrac UPA. The maximum distance of surface irregularities is calculated using a SEM image.

Mv=5.2 μm

Mv/Mn=1.75

Ratio of maximum distance of surface irregularities to particle diameter=15%

The above ultraviolet-curable composition prepared as in Example 1 is supplied to an intermediate transfer belt by a curable composition layer forming device to form an ultraviolet-curable composition layer. Next, inks of respective colors are applied onto the ultraviolet-curable composition layer using an ink-jet head to form an image. The ultraviolet-curable composition layer is then irradiated with a UV-LED lamp while bringing the ultraviolet-curable composition layer into contact with a recording medium by using a transfer device, thereby curing the ultraviolet-curable composition layer. The cured layer is separated from the intermediate transfer belt and transferred to the recording medium. The thickness of the cured layer transferred to the recording medium is 10 μm.

### (Evaluation)

A water droplet is dropped on a non-printed portion of the recorded image, and is then wiped off. The portion where the water droplet is dropped and then wiped off is compared with another non-printed portion. In the portion where the water droplet is dropped and then wiped off, the glossiness at an angle of incidence of 60° is 34. In the other non-printed portion where no water droplet is dropped, the glossiness at an angle of incidence of 60° is 95. Thus, the glossiness of the portion where the water droplet is dropped and then wiped off decreases, and a large difference in the image quality from the portion where no water droplet is dropped is observed.

To evaluate the image quality, a one-dot line is printed and the occurrence of bleeding is examined. Feathering is detected, though the degree thereof is slight.

### COMPARATIVE EXAMPLE 2

An aqueous polymer emulsion prepared as in Example 3 is dried with a spray dryer, and particle classification is then conducted with a cyclone classifier to obtain aggregate liquid-absorbing particles. The liquid-absorbing particles are dispersed in an ultraviolet-curable material having the same composition as that of Example 3 to prepare an ultraviolet-curable composition. The weight ratio of the particles contained in the ultraviolet-curable composition is 25% by weight.

The volume-average particle diameter (Mv) and the ratio (Mv/Mn) of the volume-average particle diameter to the number-average particle diameter are measured using Microtrac UPA. The maximum distance of surface irregularities is calculated using a SEM image.

Mv=2,400 nm

Mv/Mn=1.22

Ratio of maximum distance of surface irregularities to particle diameter=12%

The above ultraviolet-curable composition prepared as in Example 3 is supplied to an intermediate transfer belt by a curable composition layer forming device to form an ultraviolet-curable composition layer. Next, inks of respective colors are applied onto the ultraviolet-curable composition layer using an ink-jet head to form an image. The ultraviolet-curable composition layer is then irradiated with a UV-LED lamp while bringing the ultraviolet-curable composition layer into contact with a recording medium by using a transfer device, thereby curing the ultraviolet-curable composition layer. The cured layer is separated from the intermediate transfer belt and transferred to the recording medium. The thickness of the cured layer transferred to the recording medium is 25 μm.

### (Evaluation)

A water droplet is dropped on a non-printed portion of the recorded image, and is then wiped off. The portion where the water droplet is dropped and then wiped off is compared with another non-printed portion. In the portion where the water droplet is dropped and then wiped off, the glossiness at an angle of incidence of 60° is 70. In the other non-printed portion where no water droplet is dropped, the glossiness at an angle of incidence of 60° is 95. Thus, the glossiness of the portion where the water droplet is dropped and then wiped off decreases, and a difference in the image quality from the portion where no water droplet is dropped is detected.

To evaluate the image quality, a one-dot line is printed and the occurrence of bleeding is examined. Feathering is detected, though the degree thereof is slight.

### COMPARATIVE EXAMPLE 3

Synthesis is conducted using styrene, ethyl methacrylate, and acrylic acid monomers by solution polymerization to prepare a copolymerized polymer. This aqueous polymer emulsion is used after being neutralized by adding NaOH. The polymer after neutralization is microdispersed in an ultraviolet-curable material having the same composition as that of Example 5 to prepare an ultraviolet-curable composition. The weight ratio of particles contained in the ultraviolet-curable composition is 25% by weight.

The volume-average particle diameter (Mv) and the ratio (Mv/Mn) of the volume-average particle diameter to the number-average particle diameter are measured using Microtrac UPA. The maximum distance of surface irregularities is calculated using a SEM image.

Mv=1,250 nm

Mv/Mn=1.35

Ratio of maximum distance of surface irregularities to particle diameter=5.8%

The above ultraviolet-curable composition prepared as in Example 5 is supplied to an intermediate transfer belt by a curable composition layer forming device to form an ultraviolet-curable composition layer. Next, inks of respective colors are applied onto the ultraviolet-curable composition layer using an ink-jet head to form an image. The ultraviolet-curable composition layer is then irradiated with a metal halide lamp while bringing the ultraviolet-curable composition layer into contact with a recording medium by using a transfer device, thereby curing the ultraviolet-curable composition layer. The cured layer is separated from the intermediate transfer belt and transferred to the recording medium. The thickness of the cured layer transferred to the recording medium is 20 μm.

### (Evaluation)

A water droplet is dropped on a non-printed portion of the recorded image, and is then wiped off. The portion where the water droplet is dropped and then wiped off is compared with another non-printed portion. In the portion where the water droplet is dropped and then wiped off, the glossiness at an angle of incidence of 60° is 68. In the other non-printed portion where no water droplet is dropped, the glossiness at an angle of incidence of 60° is 95. Thus, the glossiness of the portion where the water droplet is dropped and then wiped off decreases, and a difference in the image quality from the portion where no water droplet is dropped is detected.

To evaluate the image quality, a one-dot line is printed and the occurrence of bleeding is examined. Feathering is detected, though the degree thereof is slight.

### Example 7

Synthesis is conducted by emulsion polymerization in water as in Example 1 except that styrene, butyl methacrylate, and mono-2-(methacryloyloxy)ethyl phthalate monomers are used in a molar ratio of styrene:butyl methacrylate:mono-2-(methacryloyloxy)ethyl phthalate=1:0.8:8.2, and divinylbenzene functioning as a cross-linking agent is used in an amount corresponding to 0.03 moles to prepare an aqueous emulsion of a copolymerized polymer. This aqueous polymer emulsion is used after being neutralized by adding NaOH. Particles in the neutralized aqueous polymer emulsion are transferred from the water solvent to a mixed solvent of water and IPA, and further transferred to an ultraviolet-curable material having the composition described below. Thus, an ultraviolet-curable composition in which the liquid-absorbing particles in a non-aggregated state are dispersed in the ultraviolet-curable material is prepared. The weight ratio of the particles contained in the ultraviolet-curable composition is 26% by weight.

The volume-average particle diameter (Mv) and the ratio (Mv/Mn) of the volume-average particle diameter to the number-average particle diameter are measured using Nanotrac UPA. The ratio of the maximum distance of surface irregularities to the particle diameter is calculated using a TEM image.

Mv=1,340 nm

Mv/Mn=1.20

Ratio of maximum distance of surface irregularities to particle diameter=1.1%

(Ultraviolet-curable material)

Polyurethane acrylate: 25 parts by mass

2-Hydroxypropyl acrylate: 10 parts by mass

Glycerin propoxy acrylate: 25 parts by mass

Pentaerythritol tetraacrylate: 25 parts by mass

Silicone-modified polyether acrylate: 5 parts by mass

IRGACURE 754 (Photopolymerization initiator): 4 parts by mass

The ultraviolet-curable composition prepared above is supplied to an intermediate transfer belt by a curable composition layer forming device to form an ultraviolet-curable composition layer. Next, inks of respective colors are applied onto the ultraviolet-curable composition layer using an ink-jet head to form an image. The ultraviolet-curable composition layer is then irradiated with a metal halide lamp while bringing the ultraviolet-curable composition layer into contact with a recording medium by using a transfer device, thereby curing the ultraviolet-curable composition layer. The cured layer is separated from the intermediate transfer belt and transferred to the recording medium. The thickness of the cured layer transferred to the recording medium is 19 μm.

### (Evaluation)

A water droplet is dropped on a non-printed portion of the recorded image, and is then wiped off. The portion where the water droplet is dropped and then wiped off is compared with another non-printed portion. In the portion where the water droplet is dropped and then wiped off, the glossiness at an angle of incidence of 60° is 82. In the other non-printed portion where no water droplet is dropped, the glossiness at an angle of incidence of 60° is 97. Although there is a slight difference in glossiness between these two portions, there is no substantial difference in visual observation and thus degradation of the image quality is not observed.

To evaluate the image quality, a one-dot line is printed and the occurrence of bleeding is examined. An image having slight defects at a level that does not cause a problem in terms of image quality is obtained.

### Example 8

Synthesis is conducted using styrene, butyl methacrylate, and methacrylic acid monomers by emulsion polymerization in water as in Example 1 except that a 0.1% aqueous sodium stearyl sulfonate solution is used instead of the aqueous sodium dialkyl sulfosuccinate solution of Example 1 to prepare an aqueous emulsion of a copolymerized polymer. This aqueous polymer emulsion is used after being neutralized by adding NaOH. Particles in the neutralized aqueous polymer emulsion are transferred from the water solvent to a mixed solvent of water and IPA, and further transferred to an ultraviolet-curable material having the composition described below. Thus, an ultraviolet-curable composition in which the liquid-absorbing particles in a non-aggregated state are dispersed in the ultraviolet-curable material is prepared. The weight ratio of the particles contained in the ultraviolet-curable composition is 22% by weight.

The volume-average particle diameter (Mv) and the ratio (Mv/Mn) of the volume-average particle diameter to the number-average particle diameter are measured using Nanotrac UPA. The ratio of the maximum distance of surface irregularities to the particle diameter is calculated using a TEM image.

Mv=115 nm

Mv/Mn=1.03

Ratio of maximum distance of surface irregularities to particle diameter=0.4%

### (Ultraviolet-Curable Material)

Aliphatic urethane acrylate oligomer: 25 parts by mass

Polyethylene glycol 400 diacrylate: 15 parts by mass

Hydroxyethyl acrylamide: 20 parts by mass

Ethoxylated trimethylolpropane acrylate: 25 parts by mass

Silicone-modified polyether acrylate: 5 parts by mass

IRGACURE 1870 (Photopolymerization initiator): 5 parts by mass

The ultraviolet-curable composition prepared above is supplied to an intermediate transfer belt by an ultraviolet curable composition layer forming device to form an ultraviolet-curable composition layer. Next, inks of respective colors are applied onto the ultraviolet-curable composition layer using an ink-jet head to form an image. The ultraviolet-curable composition layer is then irradiated with a metal halide lamp while bringing the ultraviolet-curable composition layer into contact with a recording medium by using a transfer device, thereby curing the ultraviolet-curable composition layer. The cured layer is separated from the intermediate transfer belt and transferred to the recording medium. The thickness of the cured layer transferred to the recording medium is 25 μm.

### (Evaluation)

A water droplet is dropped on a non-printed portion of the recorded image, and is then wiped off. The portion where the water droplet is dropped and then wiped off is compared with another non-printed portion. In the portion where the water droplet is dropped and then wiped off, the glossiness at an angle of incidence of 60° is 95. In the other non-printed portion where no water droplet is dropped, the glossiness at an angle of incidence of 60° is 96. Accordingly, there is no substantial difference in glossiness between these two portions.

To evaluate the image quality, a one-dot line is printed and the occurrence of bleeding is examined. A high-definition image without defects is obtained.

### Example 9

Synthesis is conducted by emulsion polymerization in water as in Example 1 except that styrene, butyl methacrylate, and mono-2-(methacryloyloxy)ethyl phthalate monomers are used in a molar ratio of styrene:butyl methacrylate:mono-2-(methacryloyloxy)ethyl phthalate=1:2:7, and divinylbenzene functioning as a cross-linking agent is used in an amount corresponding to 0.15 moles to prepare an aqueous emulsion of a copolymerized polymer. This aqueous polymer emulsion is used after being neutralized by adding NaOH. Particles in the neutralized aqueous polymer emulsion are transferred from the water solvent to a mixed solvent of water and IPA, and further transferred to an ultraviolet-curable material having the composition described below. Thus, an ultraviolet-curable composition in which the liquid-absorbing particles in a non-aggregated state are dispersed in the ultraviolet-curable material is prepared. The weight ratio of the particles contained in the ultraviolet-curable composition is 24% by weight.

The volume-average particle diameter (Mv) and the ratio (Mv/Mn) of the volume-average particle diameter to the number-average particle diameter are measured using Nanotrac UPA. The ratio of the maximum distance of surface irregularities to the particle diameter is calculated using a TEM image.

Mv=860 nm

Mv/Mn=1.11

Ratio of maximum distance of surface irregularities to particle diameter=0.9%

### (Ultraviolet-Curable Material)

Aliphatic urethane acrylate oligomer: 25 parts by mass

2-Hydroxypropyl acrylate: 10 parts by mass

Polyethylene glycol 200 diacrylate: 25 parts by mass

Tris(2-hydroxyethyl) isocyanurate triacrylate: 30 parts by mass

Silicone-modified polyether acrylate: 3 parts by mass

DISPERBYK (registered trademark)-2008 (dispersant): 1 part by mass

LUCIRIN TPO (Photopolymerization initiator): 4 parts by mass

The ultraviolet-curable composition prepared above is supplied to an intermediate transfer belt by a curable composition layer forming device to form an ultraviolet-curable composition layer. Next, inks of respective colors are applied onto the ultraviolet-curable composition layer using an ink-jet head to form an image. The ultraviolet-curable composition layer is then irradiated with a metal halide lamp while bringing the ultraviolet-curable composition layer into contact with a recording medium by using a transfer device, thereby curing the ultraviolet-curable composition layer. The cured layer is separated from the intermediate transfer belt and transferred to the recording medium. The thickness of the cured layer transferred to the recording medium is 7 μm.

### (Evaluation)

A water droplet is dropped on a non-printed portion of the recorded image, and is then wiped off. The portion where the water droplet is dropped and then wiped off is compared with another non-printed portion. In the portion where the water droplet is dropped and then wiped off, the glossiness at an angle of incidence of 60° is 94. In the other non-printed portion where no water droplet is dropped, the glossiness at an angle of incidence of 60° is 97. Accordingly, there is no substantial difference in glossiness between these two portions.

To evaluate the image quality, a one-dot line is printed and the occurrence of bleeding is examined. An image having slight defects at a level that does not cause a problem in terms of image quality is obtained.

### Example 10

An ultraviolet-curable composition layer is formed by supplying an ultraviolet-curable composition prepared as in Example 9 to an intermediate transfer belt by a curable composition layer forming device. In the formation of the layer, coating is conducted multiple times so that the thickness of the resulting cured layer is larger than that of Example 9. Next, inks of respective colors are applied onto the ultraviolet-curable composition layer using an ink-jet head to form an image. The ultraviolet-curable composition layer is then irradiated with a metal halide lamp while bringing the ultraviolet-curable composition layer into contact with a recording medium by using a transfer device, thereby curing the ultraviolet-curable composition layer. The cured layer is separated from the intermediate transfer belt and transferred to the recording medium. The thickness of the cured layer transferred to the recording medium is 35 μm.

### (Evaluation)

A water droplet is dropped on a non-printed portion of the recorded image, and is then wiped off. The portion where the water droplet is dropped and then wiped off is compared with another non-printed portion. In the portion where the water droplet is dropped and then wiped off, the glossiness at an angle of incidence of 60° is 81. In the other non-printed portion where no water droplet is dropped, the glossiness at an angle of incidence of 60° is 95. Although there is a slight difference in glossiness between these two portions, there is no substantial difference in visual observation and thus degradation of the image quality is not observed.

To evaluate the image quality, a one-dot line is printed and the occurrence of bleeding is examined. A high-definition image without defects is obtained.

### Example 11

Synthesis is conducted by emulsion polymerization in water as in Example 1 except that styrene, butyl methacrylate, and mono-2-(methacryloyloxy)ethyl phthalate monomers are used in a molar ratio of styrene:butyl methacrylate:mono-2-(methacryloyloxy)ethyl phthalate=1:2.8:6.2, and divinylbenzene functioning as a cross-linking agent is used in an amount corresponding to 0.08 moles to prepare an aqueous emulsion of a copolymerized polymer. This aqueous polymer emulsion is used after being neutralized by adding NaOH. Particles in the neutralized aqueous polymer emulsion are transferred from the water solvent to a mixed solvent of water and IPA, and further transferred to an ultraviolet-curable material having the composition described below. Thus, an ultraviolet-curable composition in which the liquid-absorbing particles in a non-aggregated state are dispersed in the ultraviolet-curable material is prepared. The weight ratio of the particles contained in the ultraviolet-curable composition is 8% by weight.

The volume-average particle diameter (Mv) and the ratio (Mv/Mn) of the volume-average particle diameter to the number-average particle diameter are measured using Nanotrac UPA. The ratio of the maximum distance of surface irregularities to the particle diameter is calculated using a TEM image.

Mv=630 nm

Mv/Mn=1.17

Ratio of maximum distance of surface irregularities to particle diameter=2.2%

### (Ultraviolet-Curable Material)

Polyurethane acrylate: 30 parts by mass

Trimethylolpropane ethoxy triacrylate: 35 parts by mass

Polyethylene glycol 400 diacrylate: 15 parts by mass

Hydroxyethyl acrylate: 10 parts by mass

Silicone-modified polyether acrylate: 5 parts by mass

Solsperse 39000 (dispersant): 0.2 parts by mass

IRGACURE 754 (Photopolymerization initiator): 4 parts by mass

The ultraviolet-curable composition prepared above is supplied to an intermediate transfer belt by a curable composition layer forming device to form an ultraviolet-curable composition layer. Next, inks of respective colors are applied onto the ultraviolet-curable composition layer using an ink-jet head to form an image. The ultraviolet-curable composition layer is then irradiated with a UV-LED lamp while bringing the ultraviolet-curable composition layer into contact with a recording medium by using a transfer device, thereby curing the ultraviolet-curable composition layer. The cured layer is separated from the intermediate transfer belt and transferred to the recording medium. The thickness of the cured layer transferred to the recording medium is 15 μm.

### (Evaluation)

A water droplet is dropped on a non-printed portion of the recorded image, and is then wiped off. The portion where the water droplet is dropped and then wiped off is compared with another non-printed portion. In the portion where the water droplet is dropped and then wiped off, the glossiness at an angle of incidence of 60° is 96. In the other non-printed portion where no water droplet is dropped, the glossiness at an angle of incidence of 60° is 97. Accordingly, there is no difference in glossiness between these two portions.

To evaluate the image quality, a one-dot line is printed and the occurrence of bleeding is examined. An image having slight defects at a level that does not cause a problem in terms of image quality is obtained.

### Example 12

An aqueous polymer emulsion prepared by conducting polymerization and neutralization as in Example 11 is used. Particles in the aqueous polymer emulsion are transferred from a water solvent to a mixed solvent of water and IPA, and further transferred to an ultraviolet-curable material having the composition described below. Thus, an ultraviolet-curable composition in which the liquid-absorbing particles in a non-aggregated state are dispersed in the ultraviolet-curable material is prepared. The weight ratio of the particles contained in the ultraviolet-curable composition is 42% by weight.

The volume-average particle diameter (Mv) and the ratio (Mv/Mn) of the volume-average particle diameter to the number-average particle diameter are measured using Nanotrac UPA. The ratio of the maximum distance of surface irregularities to the particle diameter is calculated using a TEM image.

Mv=630 nm

Mv/Mn=1.17

Ratio of maximum distance of surface irregularities to particle diameter=2.2%

### (Ultraviolet-Curable Material)

Polyurethane acrylate: 30 parts by mass

Trimethylolpropane ethoxy triacrylate: 35 parts by mass

Polyethylene glycol 400 diacrylate: 15 parts by mass

Hydroxyethyl acrylate: 10 parts by mass

Silicone-modified polyether acrylate: 5 parts by mass

Solsperse 39000 (dispersant): 2 parts by mass

IRGACURE 754 (Photopolymerization initiator): 4 parts by mass

The ultraviolet-curable composition prepared above is supplied to an intermediate transfer belt by a curable composition layer forming device to form an ultraviolet-curable composition layer. Next, inks of respective colors are applied onto the ultraviolet-curable composition layer using an ink-jet head to form an image. The ultraviolet-curable composition layer is then irradiated with a UV-LED lamp while bringing the ultraviolet-curable composition layer into contact with a recording medium by using a transfer device, thereby curing the ultraviolet-curable composition layer. The cured layer is separated from the intermediate transfer belt and transferred to the recording medium. The thickness of the cured layer transferred to the recording medium is 15 μm.

### (Evaluation)

A water droplet is dropped on a non-printed portion of the recorded image, and is then wiped off. The portion where the water droplet is dropped and then wiped off is compared with another non-printed portion. In the portion where the water droplet is dropped and then wiped off, the glossiness at an angle of incidence of 60° is 78. In the other non-printed portion where no water droplet is dropped, the glossiness at an angle of incidence of 60° is 95. Although there is a difference in glossiness between these two portions, there is no substantial difference in visual observation and thus degradation of the image quality is not observed.

To evaluate the image quality, a one-dot line is printed and the occurrence of bleeding is examined. A high-definition image without defects is obtained.

### Example 13

An aqueous polymer emulsion prepared as in Example 11 is used. Particles in the aqueous polymer emulsion are transferred from a water solvent to a mixed solvent of water and IPA, and further transferred to an ultraviolet-curable material having the composition described below. Thus, an ultraviolet-curable composition in which the liquid-absorbing particles in a non-aggregated state are dispersed in the ultraviolet-curable material is prepared. The weight ratio of the particles contained in the ultraviolet-curable composition is 12% by weight.

The volume-average particle diameter (Mv) and the ratio (Mv/Mn) of the volume-average particle diameter to the number-average particle diameter are measured using Nanotrac UPA. The ratio of the maximum distance of surface irregularities to the particle diameter is calculated using a TEM image.

Mv=630 nm

Mv/Mn=1.17

Ratio of maximum distance of surface irregularities to particle diameter=2.2%

### (Ultraviolet-Curable Material)

Aliphatic urethane acrylate oligomer: 25 parts by mass

Trimethylolpropane ethoxy triacrylate: 25 parts by mass

1,6-Hexanediol diacrylate: 15 parts by mass

Hydroxyethyl acetamide: 20 parts by mass

Silicone-modified polyether acrylate: 5 parts by mass

DISPERBYK-168 (dispersant): 0.5 parts by mass

IRGACURE 127 (Photopolymerization initiator): 4 parts by mass

The ultraviolet-curable composition prepared above is supplied to an intermediate transfer belt by a curable composition layer forming device to form an ultraviolet-curable composition layer. Next, inks of respective colors are applied onto the ultraviolet-curable composition layer using an ink-jet head to form an image. The ultraviolet-curable composition layer is then irradiated with a UV-LED lamp while bringing the ultraviolet-curable composition layer into contact with a recording medium by using a transfer device, thereby curing the ultraviolet-curable composition layer. The cured layer is separated from the intermediate transfer belt and transferred to the recording medium. The thickness of the cured layer transferred to the recording medium is 15 μm.

### (Evaluation)

A water droplet is dropped on a non-printed portion of the recorded image, and is then wiped off. The portion where the water droplet is dropped and then wiped off is compared with another non-printed portion. In the portion where the water droplet is dropped and then wiped off, the glossiness at an angle of incidence of 60° is 96. In the other non-printed portion where no water droplet is dropped, the glossiness at an angle of incidence of 60° is 97. Accordingly, there is no difference in glossiness between these two portions.

To evaluate the image quality, a one-dot line is printed and the occurrence of bleeding is examined. A high-definition image without defects is obtained.

### Example 14

An aqueous polymer emulsion prepared by conducting polymerization and neutralization as in Example 11 is used. Particles in the aqueous polymer emulsion are transferred from a water solvent to a mixed solvent of water and IPA, and further transferred to an ultraviolet-curable material having the composition described below. Thus, an ultraviolet-curable composition in which the liquid-absorbing particles in a non-aggregated state are dispersed in the ultraviolet-curable material is prepared. The weight ratio of the particles contained in the ultraviolet-curable composition is 38% by weight.

The volume-average particle diameter (Mv) and the ratio (Mv/Mn) of the volume-average particle diameter to the number-average particle diameter are measured using Nanotrac UPA. The ratio of the maximum distance of surface irregularities to the particle diameter is calculated using a TEM image.

Mv=630 nm

Mv/Mn=1.17

Ratio of maximum distance of surface irregularities to particle diameter=2.2%

### (Ultraviolet-Curable Material)

Aliphatic urethane acrylate oligomer: 25 parts by mass

Trimethylolpropane ethoxy triacrylate: 25 parts by mass

1,6-Hexanediol diacrylate: 15 parts by mass

Hydroxyethyl acetamide: 20 parts by mass

Silicone-modified polyether acrylate: 5 parts by mass

DISPERBYK-168 (dispersant): 1.5 parts by mass

IRGACURE 127 (Photopolymerization initiator): 4 parts by mass

The ultraviolet-curable composition prepared above is supplied to an intermediate transfer belt by a curable composition layer forming device to form an ultraviolet-curable composition layer. Next, inks of respective colors are applied onto the ultraviolet-curable composition layer using an ink-jet head to form an image. The ultraviolet-curable composition layer is then irradiated with a UV-LED lamp while bringing the ultraviolet-curable composition layer into contact with a recording medium by using a transfer device, thereby curing the ultraviolet-curable composition layer. The cured layer is separated from the intermediate transfer belt and transferred to the recording medium. The thickness of the cured layer transferred to the recording medium is 15 μm.

### (Evaluation)

A water droplet is dropped on a non-printed portion of the recorded image, and is then wiped off. The portion where the water droplet is dropped and then wiped off is compared with another non-printed portion. In the portion where the water droplet is dropped and then wiped off, the glossiness at an angle of incidence of 60° is 85. In the other non-printed portion where no water droplet is dropped, the glossiness at an angle of incidence of 60° is 96. Although there is a slight difference in glossiness between these two portions, there is no substantial difference in visual observation and thus degradation of the image quality is not observed.

To evaluate the image quality, a one-dot line is printed and the occurrence of bleeding is examined. A high-definition image without defects is obtained.

### COMPARATIVE EXAMPLE 4

An aqueous polymer emulsion prepared as in Example 1 is dried with a spray dryer, and particle classification is then repeatedly conducted using a pneumatic classifier and a sonic sieve to obtain aggregate particles formed by aggregation of liquid-absorbing particles. The liquid-absorbing particles (aggregate particles) are dispersed in an ultraviolet-curable material having the same composition as that of Example 1 to prepare an ultraviolet-curable composition. The weight ratio of the particles contained in the ultraviolet-curable composition is 15% by weight.

The volume-average particle diameter (Mv) and the ratio (Mv/Mn) of the volume-average particle diameter to the number-average particle diameter are measured using Microtrac UPA. The maximum distance of surface irregularities is calculated using a SEM image.

Mv=1.6 μm

Mv/Mn=1.19

Ratio of maximum distance of surface irregularities to particle diameter=18%

The above ultraviolet-curable composition prepared as in Example 1 is supplied to an intermediate transfer belt by a curable composition layer forming device to form an ultraviolet-curable composition layer. Next, inks of respective colors are applied onto the ultraviolet-curable composition layer using an ink-jet head to form an image. The ultraviolet-curable composition layer is then irradiated with a UV-LED lamp while bringing the ultraviolet-curable composition layer into contact with a recording medium by using a transfer device, thereby curing the ultraviolet-curable composition layer. The cured layer is separated from the intermediate transfer belt and transferred to the recording medium. The thickness of the cured layer transferred to the recording medium is 12 μm.

### (Evaluation)

A water droplet is dropped on a non-printed portion of the recorded image, and is then wiped off. The portion where the water droplet is dropped and then wiped off is compared with another non-printed portion. In the portion where the water droplet is dropped and then wiped off, the glossiness at an angle of incidence of 60° is 45. In the other non-printed portion where no water droplet is dropped, the glossiness at an angle of incidence of 60° is 96. Thus, the glossiness of the portion where the water droplet is dropped and then wiped off decreases, and a large difference in the image quality from the portion where no water droplet is dropped is observed.

To evaluate the image quality, a one-dot line is printed and the occurrence of bleeding is examined. Feathering is detected, though the degree thereof is slight.

### COMPARATIVE EXAMPLE 5

An aqueous polymer emulsion prepared as in Example 1 is dried with a spray dryer, and particle classification is then repeatedly conducted using an elbow-jet classifier and a vibration sieve to obtain aggregate particles formed by aggregation of liquid-absorbing particles. The liquid-absorbing particles (aggregate particles) are dispersed in an ultraviolet-curable material having the same composition as that of Example 1 to prepare an ultraviolet-curable composition. The weight ratio of the particles contained in the ultraviolet-curable composition is 17% by weight.

The volume-average particle diameter (Mv) and the ratio (Mv/Mn) of the volume-average particle diameter to the number-average particle diameter are measured using Microtrac UPA. The maximum distance of surface irregularities is calculated using a SEM image.

Mv=1.2 μm

Mv/Mn=1.20

Ratio of maximum distance of surface irregularities to particle diameter=20%

The above ultraviolet-curable composition prepared as in Example 1 is supplied to an intermediate transfer belt by a curable composition layer forming device to form an ultraviolet-curable composition layer. Next, inks of respective colors are applied onto the ultraviolet-curable composition layer using an ink-jet head to form an image. The ultraviolet-curable composition layer is then irradiated with a UV-LED lamp while bringing the ultraviolet-curable composition layer into contact with a recording medium by using a transfer device, thereby curing the ultraviolet-curable composition layer. The cured layer is separated from the intermediate transfer belt and transferred to the recording medium. The thickness of the cured layer transferred to the recording medium is 14 μm.

### (Evaluation)

A water droplet is dropped on a non-printed portion of the recorded image, and is then wiped off. The portion where the water droplet is dropped and then wiped off is compared with another non-printed portion. In the portion where the water droplet is dropped and then wiped off, the glossiness at an angle of incidence of 60° is 60. In the other non-printed portion where no water droplet is dropped, the glossiness at an angle of incidence of 60° is 95. Thus, the glossiness of the portion where the water droplet is dropped and then wiped off decreases, and a large difference in the image quality from the portion where no water droplet is dropped is observed.

To evaluate the image quality, a one-dot line is printed and the occurrence of bleeding is examined. Feathering is detected, though the degree thereof is slight.

### COMPARATIVE EXAMPLE 6

Solution polymerization is conducted in water using sodium methacrylate monomer and methacrylic acid monomer, and drying is then conducted by evaporating water by heating to obtain a bulk copolymerized polymer. The copolymerized polymer is repeatedly subjected to pneumatic pulverization/classification. The resulting particles are then dispersed in an ultraviolet-curable material having the same composition as that of Example 1 to prepare an ultraviolet-curable composition in which the liquid-absorbing particles in a non-aggregated state are dispersed. The weight ratio of the particles contained in the ultraviolet-curable composition is 22% by weight.

The volume-average particle diameter (Mv) and the ratio (Mv/Mn) of the volume-average particle diameter to the number-average particle diameter are measured using Microtrac UPA. The maximum distance of surface irregularities is calculated using a SEM image.

Mv=1,450 nm

Mv/Mn=1.85

Ratio of maximum distance of surface irregularities to particle diameter=34%

The above ultraviolet-curable composition prepared as in Example 1 is supplied to an intermediate transfer belt by a curable composition layer forming device to form an ultraviolet-curable composition layer. Next, inks of respective colors are applied onto the ultraviolet-curable composition layer using an ink-jet head to form an image. The ultraviolet-curable composition layer is then irradiated with a UV-LED lamp while bringing the ultraviolet-curable composition layer into contact with a recording medium by using a transfer device, thereby curing the ultraviolet-curable composition layer. The cured layer is separated from the intermediate transfer belt and transferred to the recording medium. The thickness of the cured layer transferred to the recording medium is 18 μm.

### (Evaluation)

A water droplet is dropped on a non-printed portion of the recorded image, and is then wiped off. The portion where the water droplet is dropped and then wiped off is compared with another non-printed portion. In the portion where the water droplet is dropped and then wiped off, the glossiness at an angle of incidence of 60° is 55. In the other non-printed portion where no water droplet is dropped, the glossiness at an angle of incidence of 60° is 96. Thus, the glossiness of the portion where the water droplet is dropped and then wiped off decreases, and a difference in the image quality from the portion where no water droplet is dropped is detected.

To evaluate the image quality, a one-dot line is printed and the occurrence of bleeding is examined. Feathering is detected, though the degree thereof is slight.

Table 1 shows properties of the liquid-absorbing particles used in Examples and Comparative Examples, the type of dispersant, and the thickness of each of the curable composition layers after being transferred to the recording media. Table 2 shows the evaluation results.

TABLE 1

| | Liquid-absorbing particles | | | | | |
|---|---|---|---|---|---|---|
| | | | Ratio (%) of | Weight ratio of | | |
| | | | maximum distance of | liquid-absorbing | | Thickness |
| | | | surface irregularities | particles | | of cured |
| | Mv (nm) | Mv/Mn | to particle diameter | (wt %) | Dispersant | layer (μm) |
| Example 1 | 640 | 1.09 | 0.5 | 20 | — | 10 |
| Example 2 | 640 | 1.09 | 0.5 | 30 | Solsperse 24000 | 20 |
| Example 3 | 55 | 1.14 | 0.3 | 20 | — | 8 |
| Example 4 | 1,150 | 1.11 | 0.8 | 25 | Solsperse 32000 | 25 |
| Example 5 | 650 | 1.19 | 1.2 | 22 | — | 15 |
| Example 6 | 950 | 1.12 | 4.8 | 25 | Solsperse 36000 | 18 |
| Example 7 | 1,340 | 1.20 | 1.1 | 26 | — | 19 |
| Example 8 | 115 | 1.03 | 0.4 | 22 | — | 25 |
| Example 9 | 860 | 1.11 | 0.9 | 24 | DISPERBYK-2008 | 7 |
| Example 10 | 860 | 1.11 | 0.9 | 24 | DISPERBYK-2008 | 35 |
| Example 11 | 630 | 1.17 | 2.2 | 8 | Solsperse 39000 | 15 |
| Example 12 | 630 | 1.17 | 2.2 | 42 | Solsperse 39000 | 15 |
| Example 13 | 630 | 1.17 | 2.2 | 12 | DISPERBYK-168 | 15 |
| Example 14 | 630 | 1.17 | 2.2 | 38 | DISPERBYK-168 | 15 |
| Comparative Example 1 | 5,200 | 1.75 | 15 | 25 | — | 10 |
| Comparative Example 2 | 2,400 | 1.22 | 12 | 25 | — | 25 |
| Comparative Example 3 | 1,250 | 1.35 | 5.8 | 25 | — | 20 |
| Comparative Example 4 | 1,600 | 1.19 | 18 | 15 | — | 12 |
| Comparative Example 5 | 1,200 | 1.20 | 20 | 17 | — | 14 |
| Comparative Example 6 | 1,450 | 1.85 | 34 | 22 | — | 18 |

TABLE 2

| | Evaluation | | |
|---|---|---|---|
| | Glossiness in non-printed portion | | |
| | (Angle of incidence: 60°) | | |
| | Portion where a water | Portion where no | |
| | droplet is dropped | water droplet | |
| | and then wiped off | is dropped | Image quality (One-dot line) |
| Example 1 | 95 | 96 | Feathering does not occur. |
| Example 2 | 97 | 98 | Feathering does not occur. |
| Example 3 | 93 | 95 | Feathering does not occur. |
| Example 4 | 90 | 97 | Feathering does not occur. |
| Example 5 | 95 | 97 | Feathering does not occur. |
| Example 6 | 89 | 97 | Feathering does not occur. |
| Example 7 | 82 | 97 | Feathering slightly occurs. |
| Example 8 | 95 | 96 | Feathering does not occur. |
| Example 9 | 94 | 97 | Feathering slightly occurs. |
| Example 10 | 81 | 95 | Feathering does not occur. |
| Example 11 | 96 | 97 | Feathering slightly occurs. |
| Example 12 | 78 | 95 | Feathering does not occur. |
| Example 13 | 96 | 97 | Feathering does not occur. |
| Example 14 | 85 | 96 | Feathering does not occur. |
| Comparative Example 1 | 34 | 95 | Feathering slightly occurs. |
| Comparative Example 2 | 70 | 95 | Feathering slightly occurs. |
| Comparative Example 3 | 68 | 95 | Feathering slightly occurs. |
| Comparative Example 4 | 45 | 96 | Feathering slightly occurs. |
| Comparative Example 5 | 60 | 95 | Feathering slightly occurs. |
| Comparative Example 6 | 55 | 96 | Feathering slightly occurs. |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A curable composition for image recording, comprising:
a curable material that is curable by a stimulus from the outside; and
liquid-absorbing particles that have a volume-average particle diameter in a range from about 50 nm to about 1,500 nm and a ratio volume-average particle diameter/number-average particle diameter in a range from about 1.0 to about 1.2 and that are dispersed in the curable material without aggregation.

2. The curable composition according to claim 1, wherein when a particle diameter of each of the liquid-absorbing particles is represented by the diameter D of a circle circumscribed about the outline of the liquid-absorbing particle, the radius of the circumscribed circle is represented by R, and the radius of a circle that is concentric with the circumscribed circle and is inscribed in the outline of the liquid-absorbing particle is represented by r, a ratio [(R−r)/D]×100 (%) of a maximum distance of a difference between a top and a bottom of irregularities on the surface of the liquid-absorbing particle to the particle diameter D of the liquid-absorbing particle is less than about 5%.

3. The curable composition according to claim 1, further comprising a dispersant that disperses the liquid-absorbing particles in the curable material.

4. The curable composition according to claim 2, further comprising a dispersant that disperses the liquid-absorbing particles in the curable material.

5. The curable composition according to claim 1, wherein the content of the liquid-absorbing particles is in a range from about 10% by mass to about 40% by mass.

6. The curable composition according to claim 2, wherein the content of the liquid-absorbing particles is in a range from about 10% by mass to about 40% by mass.

7. The curable composition according to claim 3, wherein the content of the liquid-absorbing particles is in a range from about 10% by mass to about 40% by mass.

8. The curable composition according to claim 4, wherein the content of the liquid-absorbing particles is in a range from about 10% by mass to about 40% by mass.

9. A method for producing the curable composition for image recording according to claim 1, the method comprising:
preparing liquid-absorbing particles dispersed in an aqueous solvent; and
mixing the liquid-absorbing particles dispersed in the aqueous solvent and a curable material that is curable by a stimulus from the outside without drying the liquid-absorbing particles.

10. An image recording apparatus comprising:
an intermediate transfer body;
a curable composition layer forming unit that forms a curable composition layer by supplying the curable composition for image recording according to claim 1 to the intermediate transfer body;
an ink application unit that applies a water-based ink onto the curable composition layer;
a transfer unit that transfers, to a recording medium, the curable composition layer to which the water-based ink is applied; and
a stimulus supply unit that supplies a stimulus for curing a curable material in the curable composition layer.

11. A method for recording an image, comprising:
forming a curable composition layer by supplying the curable composition for image recording according to claim 1 to an intermediate transfer body;
applying a water-based ink onto the curable composition layer;
transferring, to a recording medium, the curable composition layer to which the water-based ink is applied; and
supplying a stimulus for curing a curable material in the curable composition layer.
